(19) United States
(12) Patent Application Publication
(10) Pub. No.: US 2018/0307730 A1
(43) Pub. Date: Oct. 25, 2018

(54) SYSTEMS AND METHODS FOR TRACKING INFORMATION

(71) Applicant: Zinatt Technologies Inc., Indianapolis, IN (US)

(72) Inventors: Gabriel Enrique Reina, Tucson, AZ (US); Thomas Ray Hershberger, Indianapolis, IN (US)

(21) Appl. No.: 15/758,909

(22) PCT Filed: Sep. 9, 2016
(86) PCT No.: PCT/US16/50885

§ 371 Date: Mar. 9, 2018

Related U.S. Application Data
(60) Provisional application No. 62/217,385, filed on Sep. 11, 2015.
(60) Provisional application No. 62/232,724, filed on Sep. 25, 2015.

(51) Int. Cl. G06F 17/30; G06F 3/0482; G06Q 10/10

(52) U.S. Cl. CPC G06F 17/30507; G06F 17/30604; G06F 17/30525; G06Q 50/26; G06F 3/0482; G06Q 10/109; G06F 17/30289

(57) ABSTRACT

Systems are disclosed comprising, for example, a non-transitory, computer-readable storage medium on which a database management system is stored and configured to allow access and indexing of content items related to an investigation in a corpora of electronically stored content, a computer machine comprising a processor in communication with the storage medium configured to receive a first data associated with the investigation, receive a second data associated with the investigation, link the first data and the second data with the investigation, associate, by the processor, the first data with the second data, and report, by the processor, an investigative conclusion based on the association of the first data and the second data. Methods of database management for investigations are also disclosed.

### CROSS-REFERENCE TO RELATED APPLICATIONS

This application claims priority to U.S. Provisional Application Ser. No. 62/217,385, filed on Sep. 11, 2016, and U.S. Provisional Application Ser. No. 62/232,724, filed on Sep. 25, 2016, the entire disclosures of which are both hereby expressly incorporated by reference.

### BACKGROUND

This disclosure relates to systems and methods for tracking information. More specifically, this disclosure relates to systems and methods for tracking and management of investigative information.

Current investigations and reports by law enforcement are typically manually typed and manually coordinated using tables and spreadsheets with conventional office software, such as Microsoft Word® or Excel®. However, such systems lack the ability to integrate and accurately track in a timely manner the various aspects of an investigation, especially with a time sensitive investigation.

For example, an investigation—such as a drug trafficking investigation—may have multiple dynamic parts that require cross coordination between a variety of personnel with large amounts of uncategorized or untagged data. Conventional methods of tracking investigation data often require large amounts of man-hours that require repeated identical entries, which may introduce errors into the system.

Due to the nature of some errors, opportunities to gather more evidence, prevent further crimes, and apprehend suspects can be frustrated. Furthermore, some errors introduced into conventional systems—such as the efficient tracking of evidence—can unintentionally prevent obtained evidence from entering any subsequent trial and, thus, may frustrate convictions of otherwise guilty suspects.

A need therefore exists to better track, manage, and interpret data obtained during the course of an investigation.

### SUMMARY

Systems and methods disclosed herein allow for improved efficiency regarding the tracking, management, analysis, and reporting of data from an investigation. Such efficiencies can result in reduced man-hours and, thus, improved efficacy and lower costs for investigations.

Furthermore, such systems and methods may reduce the error that are typically present with conventional systems and methods in the industry.

In some embodiments, systems may include a non-transitory, computer-readable storage medium on which a database management system is stored and configured to allow access and indexing of content items related to an investigation in a corpora of electronically stored content, a computer machine comprising a processor in communication with the storage medium configured to receive a first data associated with the investigation, receive a second data associated with the investigation, link the first data and the second data with the investigation, associate, by the processor, the first data with the second data, and report, by the processor, an investigative conclusion based on the association of the first data and the second data.

Methods for managing investigation data may include receiving a first data associated with an investigation, receiving a second data associated with the investigation, linking the first data and the second data with the investigation, associating, by a processor, the first data with the second data, and reporting, by the processor, an investigative conclusion based on the association of the first data and the second data.

### BRIEF DESCRIPTION OF THE DRAWINGS

The above mentioned and other features and objects of this disclosure, and the manner of attaining them, will become more apparent and the disclosure itself will be better understood by reference to the following description of an embodiment of the disclosure taken in conjunction with the accompanying drawings, wherein:

FIG. 1 illustrates a database system for an investigation according to various embodiments;

FIG. 2 illustrates a method of managing investigation data according to various embodiments;

FIG. 3 illustrates a main screen of a graphical user interface (“GUI”) database management system according to various embodiments;

FIG. 4 illustrates the address and bank account screens of a GUI database management system according to various embodiments;

FIG. 5 illustrates an exemplary grid search screen of a GUI database management system;

FIG. 6 illustrates the wiring, branding and code term screens of a GUI database management system according to various embodiments;

FIG. 7 illustrates an agent contact screen of a GUI database management system according to various embodiments;

FIG. 8 illustrates an aircraft identification and code screen of a GUI database management system according to various embodiments;

FIG. 9 illustrates an airport code search screen of a GUI database system according to various embodiments;

FIG. 10 illustrates an area code search screen of a GUI database management system according to various embodiments;

FIG. 11 illustrates a bulletin board screen of a GUI database management system according to various embodiments;

FIG. 12 illustrates a new calendar appointment screen of a GUI database management system according to various embodiments;

FIG. 13 illustrates a calendar day view screen of a GUI database management system according to various embodiments;

FIG. 14 illustrates a calendar month view screen of a GUI database management system according to various embodiments;

FIG. 15 illustrates a screen shot of the calendar week view of a GUI database management system according to various embodiments;

FIG. 16 illustrates a case management screenshot of a GUI database management system according to various embodiments;

FIG. 17 illustrates a chat screen of a GUI database management system according to various embodiments;

FIG. 18 illustrates a country code screen of a GUI database management system according to various embodiments;

FIG. 19 illustrates a help screen of a GUI database management system according to various embodiments;

FIG. 20 illustrates a module screen of a GUI database management system according to various embodiments;

FIG. 21 illustrates various module tiles of a GUI database management system according to various embodiments;

FIG. 22 illustrates three exemplary module tiles of a GUI database management system according to various embodiments;

FIG. 23 illustrates two exemplary module tiles of a GUI database management system according to various embodiments;

FIG. 24 illustrates an add target and an add participants module of an exemplary GUI database management system;

FIG. 25 illustrates three exemplary modules having plane, flight, and export data of a GUI database management system according to various embodiments;

FIG. 26 illustrates a drug transaction tile, package tracking tile and vehicle database tile according to various embodiments;

FIG. 27 illustrates an exemplary money transaction tile and a shift report tile of a GUI database management system according to various embodiments;

FIG. 28 illustrates the add new entry for bulletin screen under the notification screen of a GUI database management system according to various embodiments;

FIG. 29 illustrates an exemplary report screen of a GUI database management system;

FIG. 30 illustrates a screen of a GUI database management system containing a plurality of banking information according to various embodiments;

FIG. 31 illustrates an exemplary search screen of a GUI database management system;

FIG. 32 illustrates a screen for determining the state abbreviation of a GUI database management system according to various embodiments;

FIG. 33 illustrates the switch case menu of a GUI database management system according to various embodiments;

FIG. 34 illustrates the contact list screen of an exemplary GUI database management system;

FIG. 35 illustrates the time-zone screen of a GUI database management system according to various embodiments;

FIG. 36 illustrates the user management screen of a GUI database management system according to various embodiments;

FIG. 37 illustrates the user list screen of a GUI database management system according to various embodiments;

FIG. 38 illustrates a target telephone (“TT”) tracker screen of a GUI database management system according to various embodiments;

FIG. 39 illustrates the addition of a TT Tracker screen of a GUI database management system according to various embodiments;

FIG. 40 illustrates the pin-to-pin (“P2P”) request list screen of a GUI database management system according to various embodiments; and

FIG. 41 illustrates the add new P2P request screen of a GUI database management system according to various embodiments.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates an embodiment of the disclosure, in one form, and such exemplifications are not to be construed as limiting the scope of the disclosure in any manner.

### DETAILED DESCRIPTION

The embodiment disclosed below is not intended to be exhaustive or limit the disclosure to the precise form disclosed in the following detailed description. Rather, the embodiment is chosen and described so that others skilled in the art may utilize its teachings.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

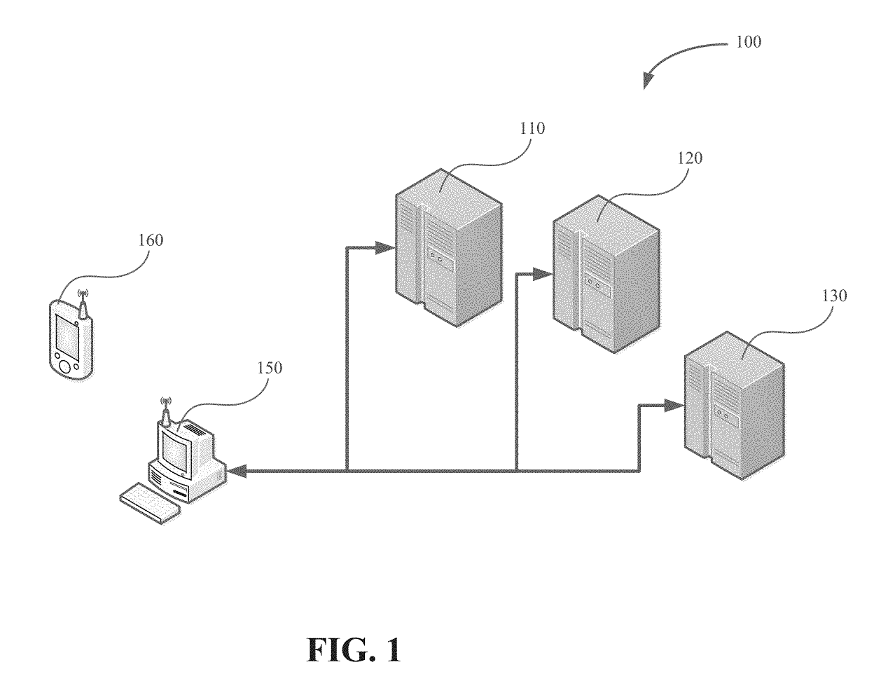

FIG. 1 illustrates system 100 according to various embodiments. System 100 may include a non-transitory, computer-readable storage medium 110 on which a database management system is stored and configured to access and index content items related to an investigation in a corpora of electronically stored content and a computer machine 150. Computer machine 150 may comprise a processor in communication with the storage medium configured to receive a first data associated with the investigation, receive a second data associated with the investigation, link the first data and the second data with the investigation, associate, by the processor, the first data with the second data, and report, by the processor, an investigative conclusion based on the association of the first data and the second data.

The processor is not particularly limited and, for example, may be a microprocessor, a micro-controller, a computer, and/or a distributed group of processing devices. Computer machine 150 may be configured to cause the processor to schedule an event based on the investigative conclusion as described infra. The event may be updated with a third data associated with the investigation.

As illustrated in FIG. 1, computer machine 150 may be in communication with more than one computer-readable storage mediums, such as second storage medium 120 and third storage medium 130. Also, the processor may be in communication with a sub-system 160 (wired or wireless) which may also include information associated with the first data associated with the investigation, the second data associated with the investigation, or both. Exemplary storage mediums can include storage mediums or databases with wire-tap information, GPS tracking information, and videos recordings. Wire-tap information can include stored information such as wire-tap recordings, text, and target telephone duration dates. GPS information can include information such as location information, time stamps, and tracking expiration dates (e.g., dates when a warrant has expired and the device must be removed). Video recording databases can include video recording information from pole cameras or sousveillance (e.g., body cameras).

Second sub-system 160 is not particularly limited and may be, for example, a second computer machine. Also, second sub-system 160 may be a sub-system capable of displaying the investigative conclusion on a graphical user interface. In various embodiments, the sub-system may be in wireless communication with the computer machine 150.

Also, the database management system 100 may be configured to be modified by at least two end users simultaneously, for example, from computer machine 150 and sub-system 160.

Moreover, database management system 100 may be configured to record and store modifications to the database management system. Thus, the database management system 100 may record, who, how, when, and what changes were made to the system, which can allow for increased reliability, accuracy, and correction of errors in the system. In various embodiments, this information may be stored in metadata, which may or may not be viewable by a particular user.

Furthermore, system 100 may allow for the first data associated with the investigation and the second data associated with the investigation to be tagged. This may allow for easier searching, association, and forecasting as the investigation progresses. The tagging is not particularly limited and may or may not be viewable by particular users.

Moreover, the tagging may be done by one or more end users (e.g., law enforcement personnel). For example, the first data associated with the investigation and the second data associated with the investigation may be received from two separate end users. Also, the first data and second data associated with the investigation may be tagged by the end users, for example, when entered into the system or after being entered into the system.

For example, system 100 may be capable of tagging the data, for example, the tag may be used to link data of an investigation, such as linking the first data associated with an investigation and the second data associated with the investigation as an investigative event. Also, system 100 may be capable of geographically tagging (e.g., associating) the data with an investigation, such as tagging the location of an investigative event. Such tagging or associating can allow for the data, summaries thereof, or investigative conclusions to be displayed on interactive maps of various areas as described below. Furthermore, once information is linked, related information may be auto-populated, for example, to assist with the reporting, organization or preparation of a summary.

In various embodiments, an event may be scheduled based on the investigative conclusion. For example, a proposed meeting for a drug transaction based on data received may be scheduled, reminders set, and geographically tagged to inform and remind law enforcement personnel working on the investigation of the event.

The investigative conclusion is not particularly limited and may include location information, vehicle identifier information, property ownership information, telephonic information, banking information, transportation information, legal information, lexical resource information, correspondence information, Title III (i.e., wiretap) information, videographic information, photographic information, financial transaction information, drug transfer information, access information, personal identification information, or mixtures thereof.

Location information may include area code information, state abbreviation information, county, parish, canton, or shire information, jurisdictional information, airport code information, time zone information, country code information, or mixtures thereof.

Correspondence information may include author information, sender information, recipient information, time stamp information, subject matter information, attachment information, shipping information, tracking information, or mixtures thereof.

Vehicle identifier information may include license plate information, vehicle identification number (“VIN”) information, plane tail identification information, make of the vehicle information, model of the vehicle information, series of the vehicle information, color of the vehicle information, customization of the vehicle information, capacity of the vehicle information, or mixtures thereof.

Transportation information may include time of arrival (“ETA”) information, time of departure information, flight information, booking information, commute time information, gate information, dock information, container information, carrier information, shipping information, bearing information, companion information, dock information, debark information, embarking information, seating information, luggage information, port information, cab information, track information, traffic information, parking information, route information, or mixtures thereof.

Personal identification information may include mug shots, gang affiliation information, cartel affiliation information, relationship information, genealogical information, educational information, professional licensure information, social security numbers, driver's license numbers, birthdate, age, height information, weight information, religious affiliation, ethnicity, nationality, scars and marks information, eye color, biographical information, internet protocol (“IP”) address information, alias information, account user information, address information, or mixtures thereof.

Banking information may include bank account numbers, balances, routing numbers, check numbers, wiring information, credit information, net worth information, loan information, investment information, credit card information, debit card information, account statements, check image information, portfolio information, mortgage information, asset allocation information, liability allocation information, currency information, or mixtures thereof.

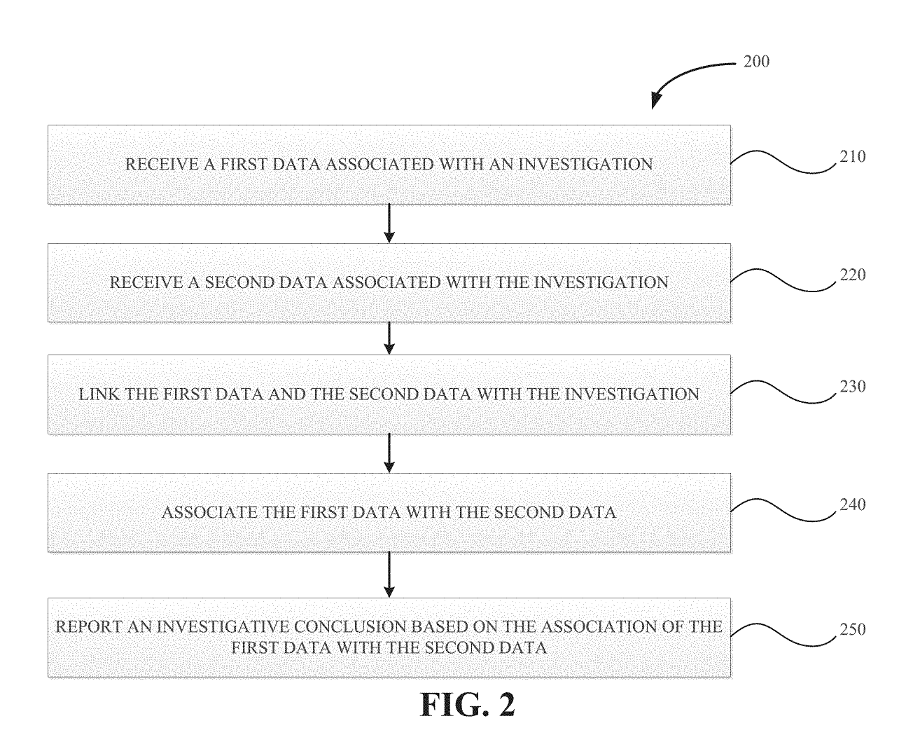

FIG. 2 illustrates method 200 which may include receiving a first data associated with an investigation (step 210) and receiving a second data associated with the investigation (step 220). The receiving is not particularly limited and may include data received from separate sources or users. For example, the first data associated with the investigation and the second data associated with the investigation may be received from two separate end users. Also, the data may be received at separate times or may be received simultaneously.

Method 200 may also include linking the first data and the second data with the investigation (step 230), associating, by a processor, the first data with the second data (step 240), and reporting, by the processor, an investigative conclusion based on the association of the first data and the second data (step 250).

The investigative conclusion is not particularly limited and can be a conclusion of an event that occurred or a forecast of an event that may occur, such as a meeting or future transaction. Thus, various methods include the scheduling of an event based on the investigative conclusion. The event may be updated based on additional data (e.g., a third data) that is associated with the investigation (e.g., flight information). Thus, the systems and methods herein may include the monitoring, altering, and reporting of dynamic scheduled events. Accordingly, users may not have to continuously monitor scheduled events, but may rely on the management systems and methods disclosed herein

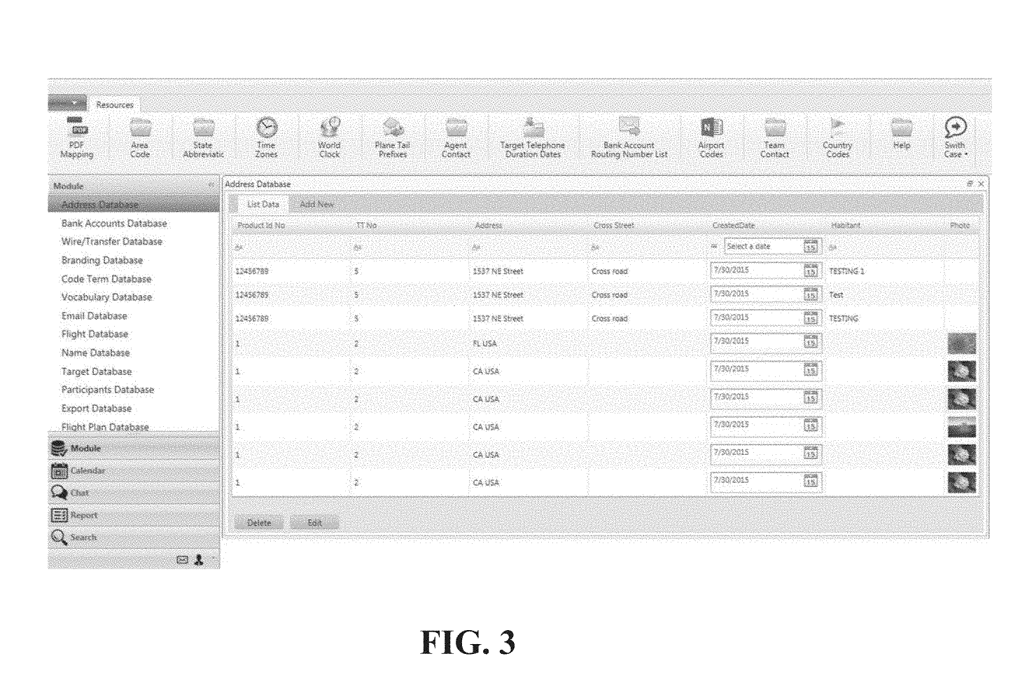

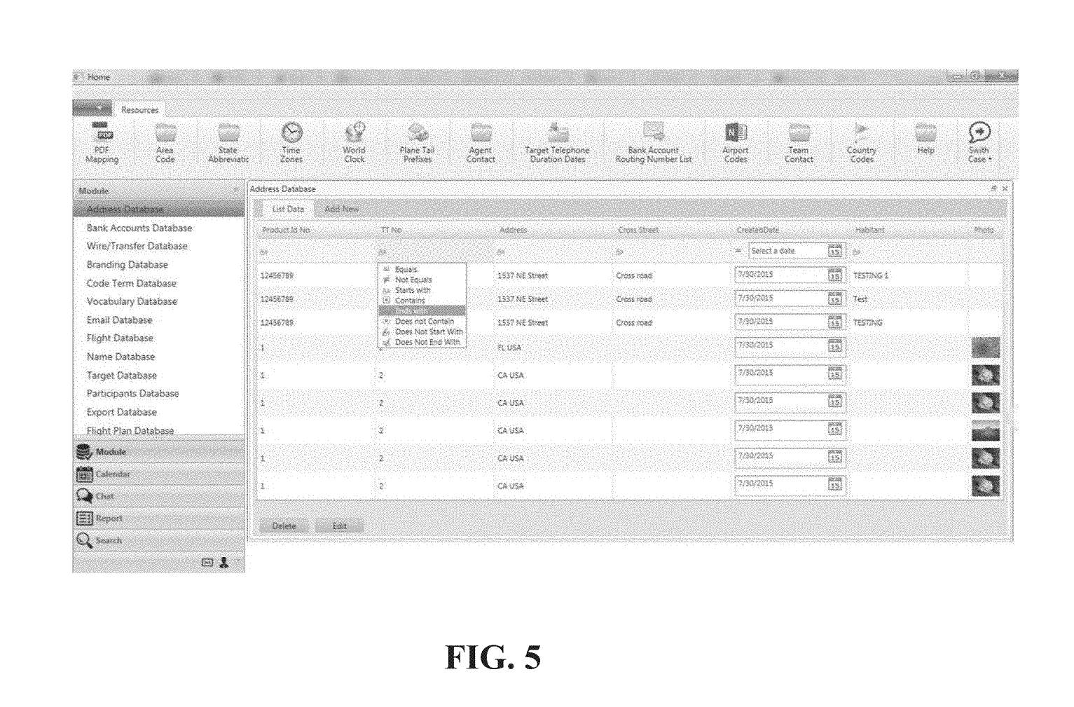

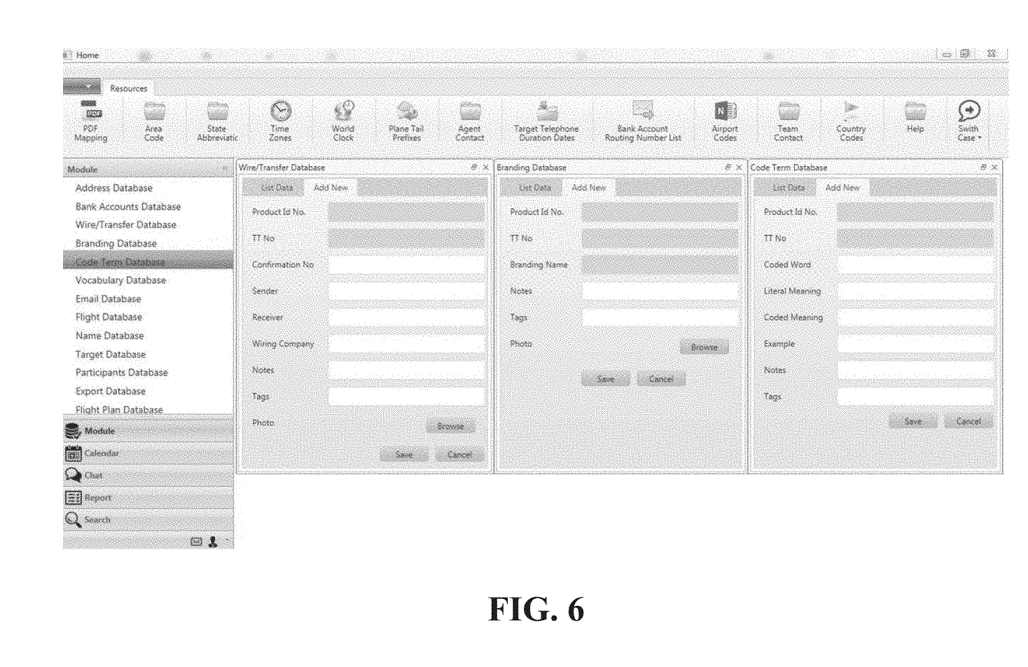

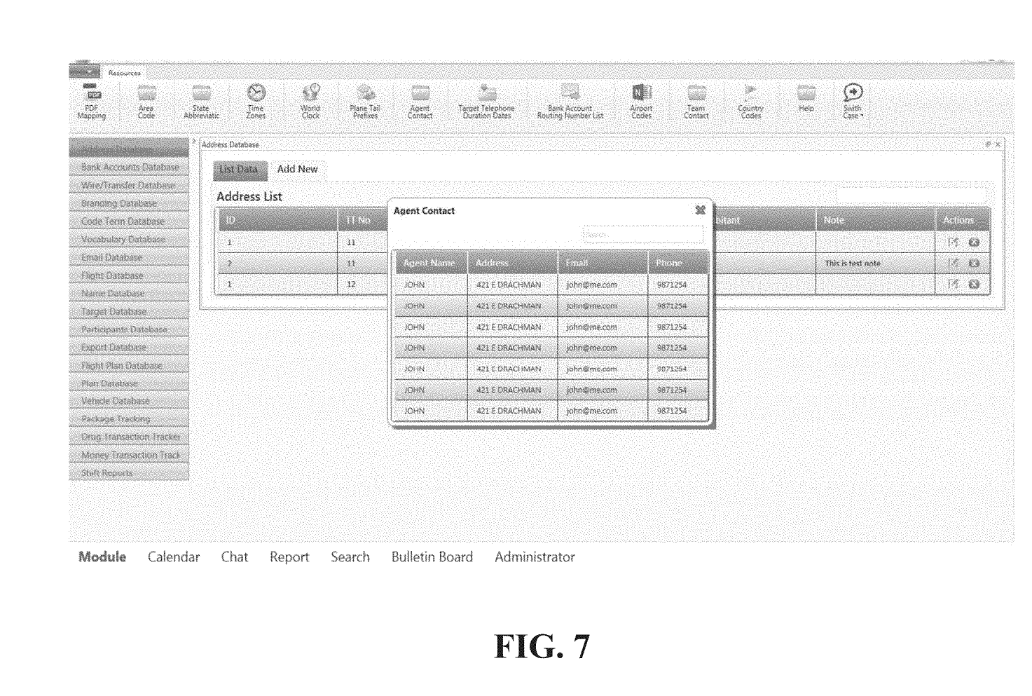

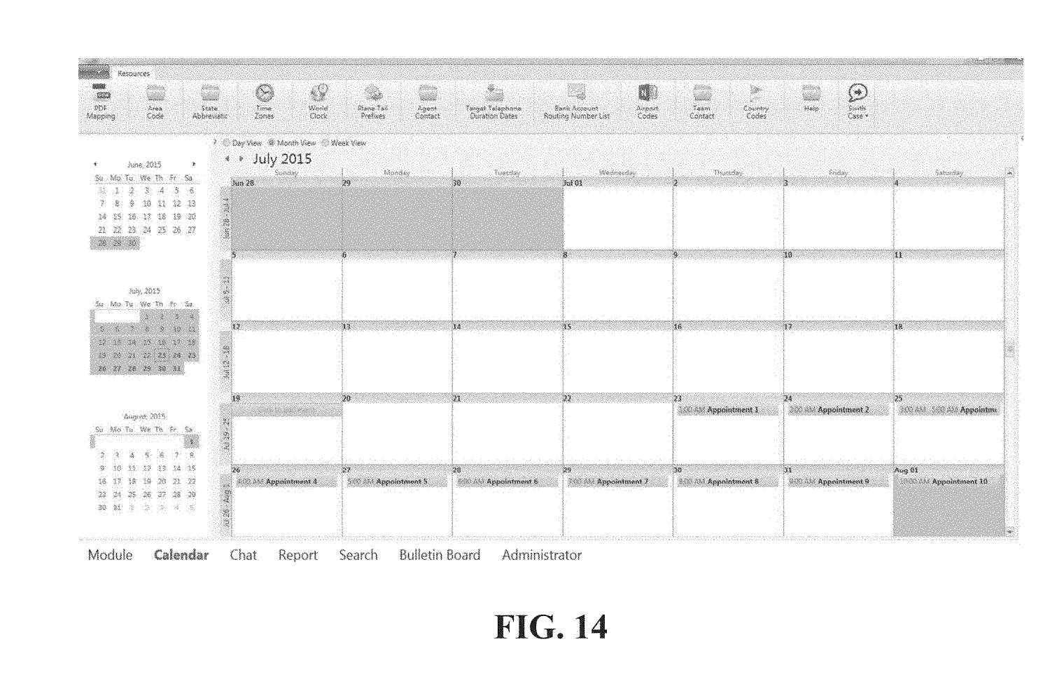

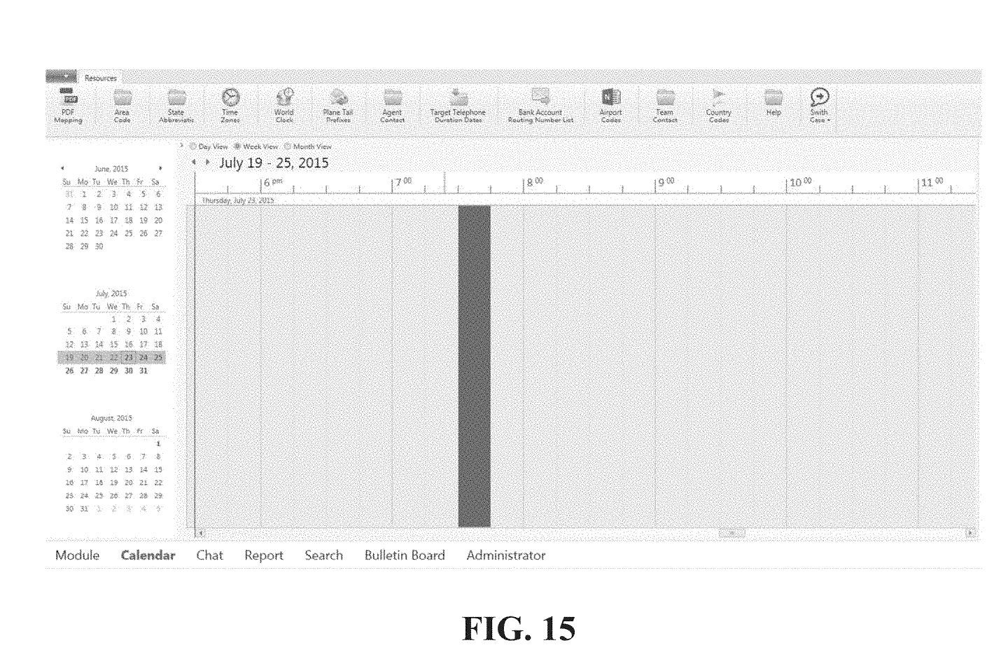

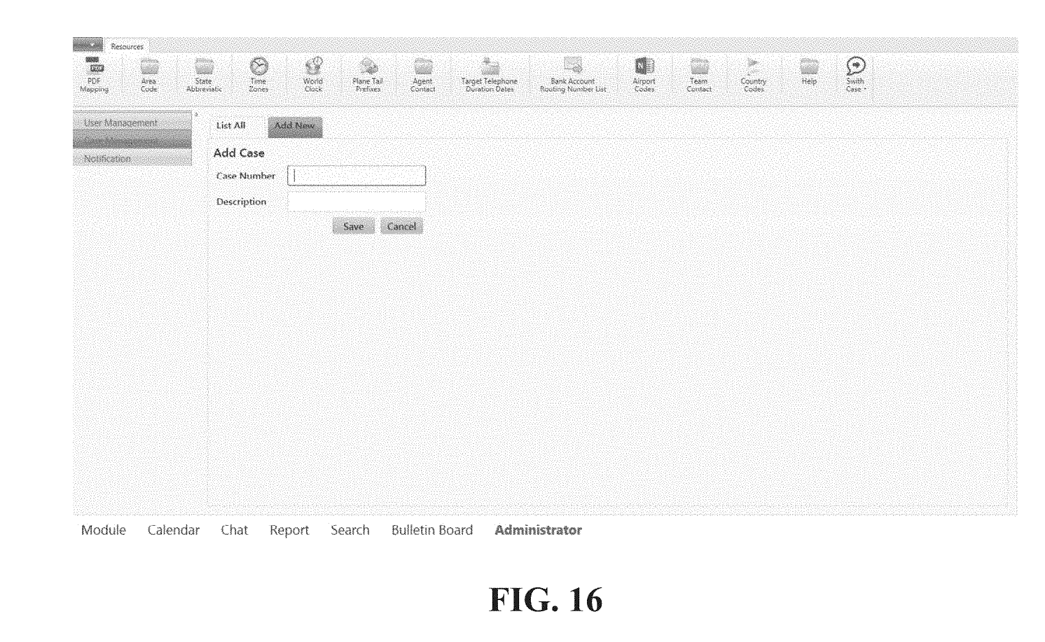

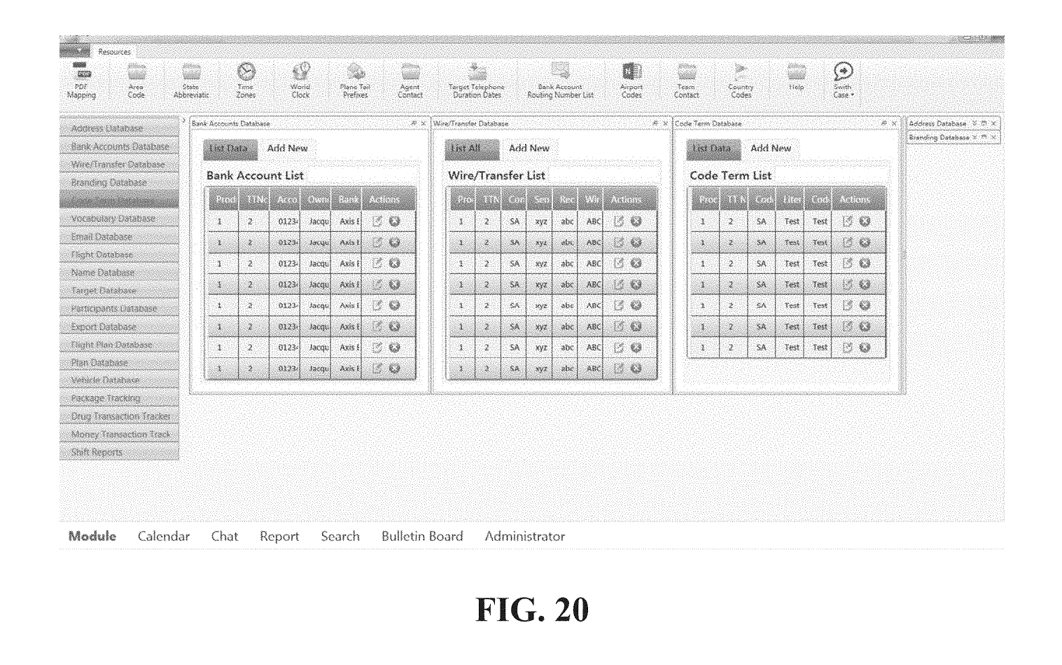

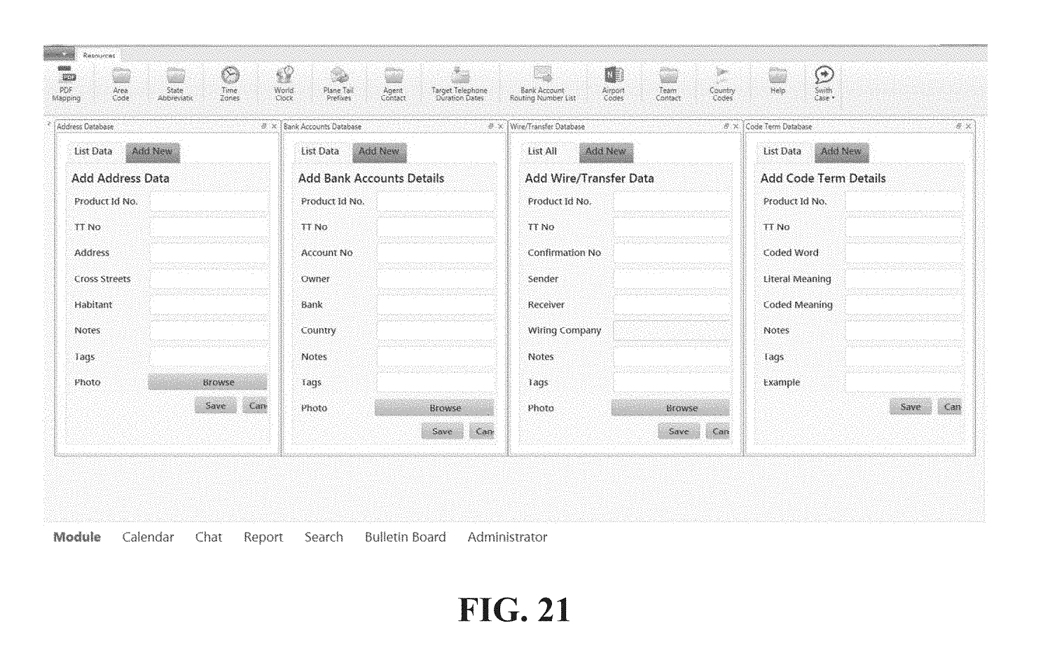

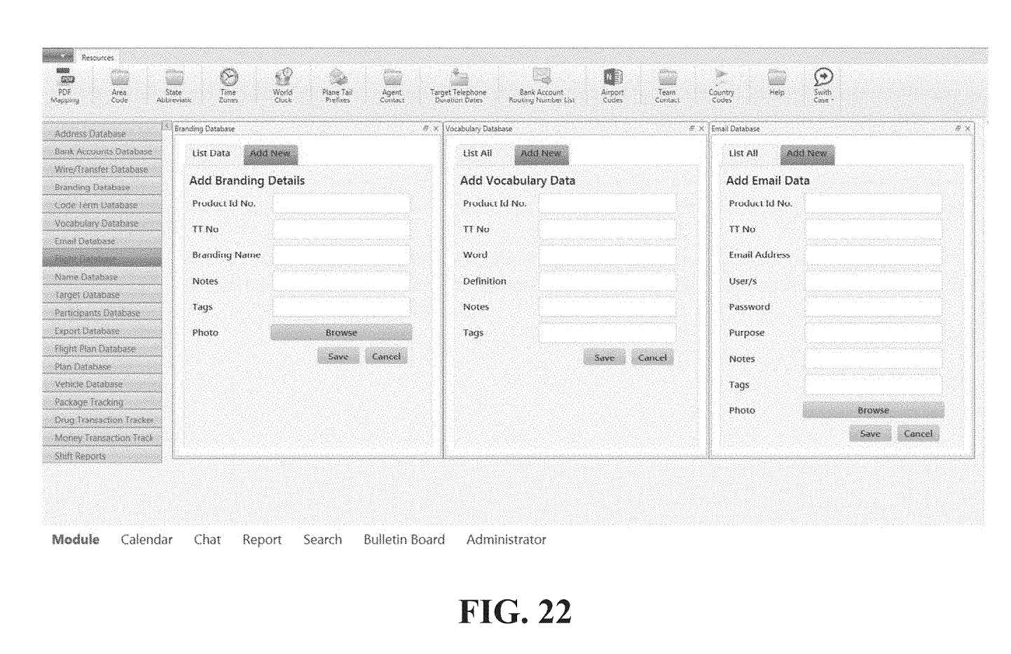

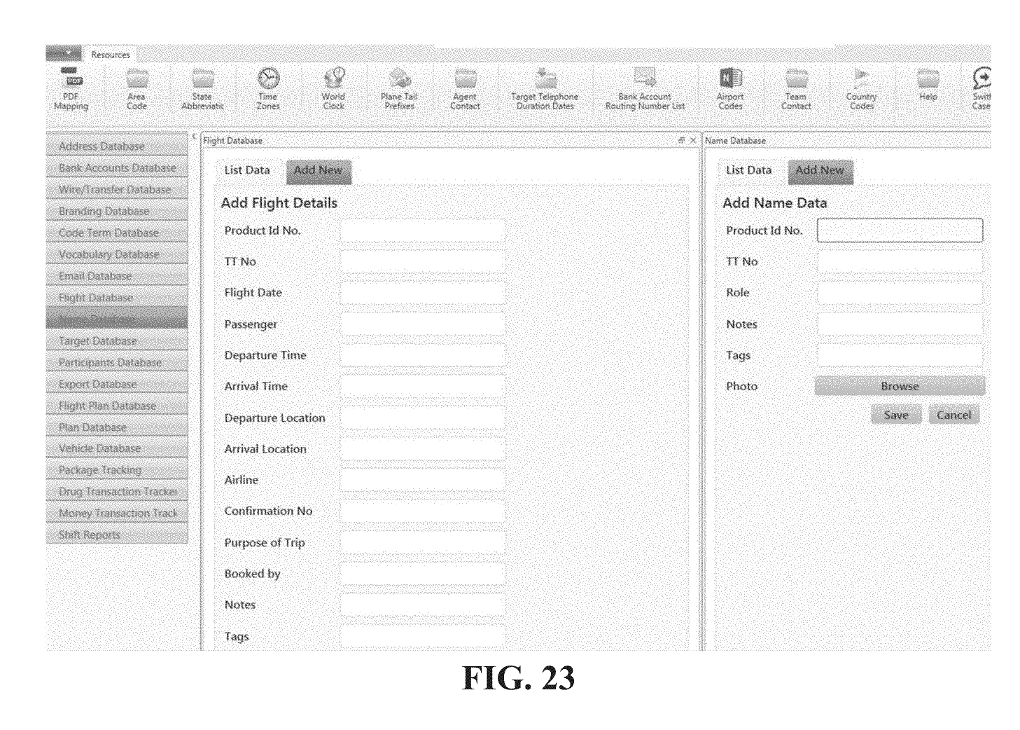

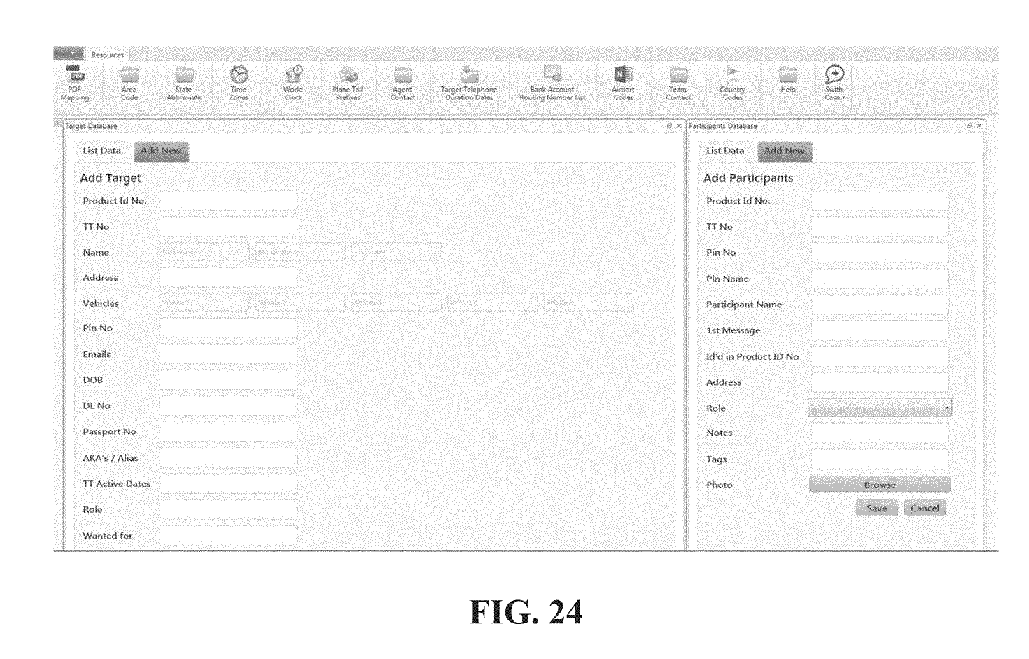

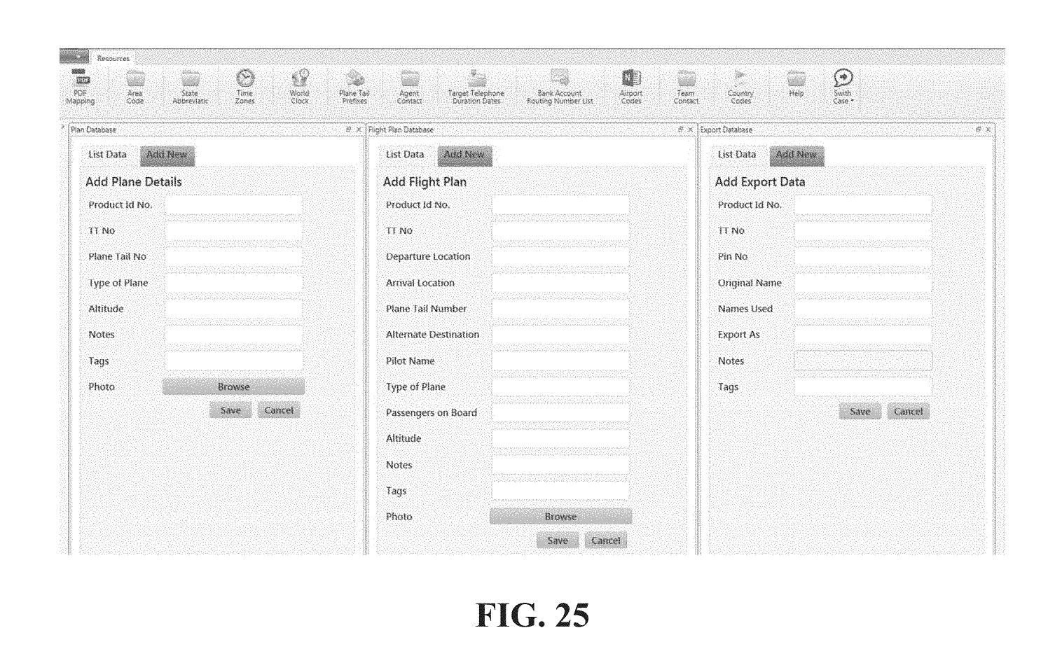

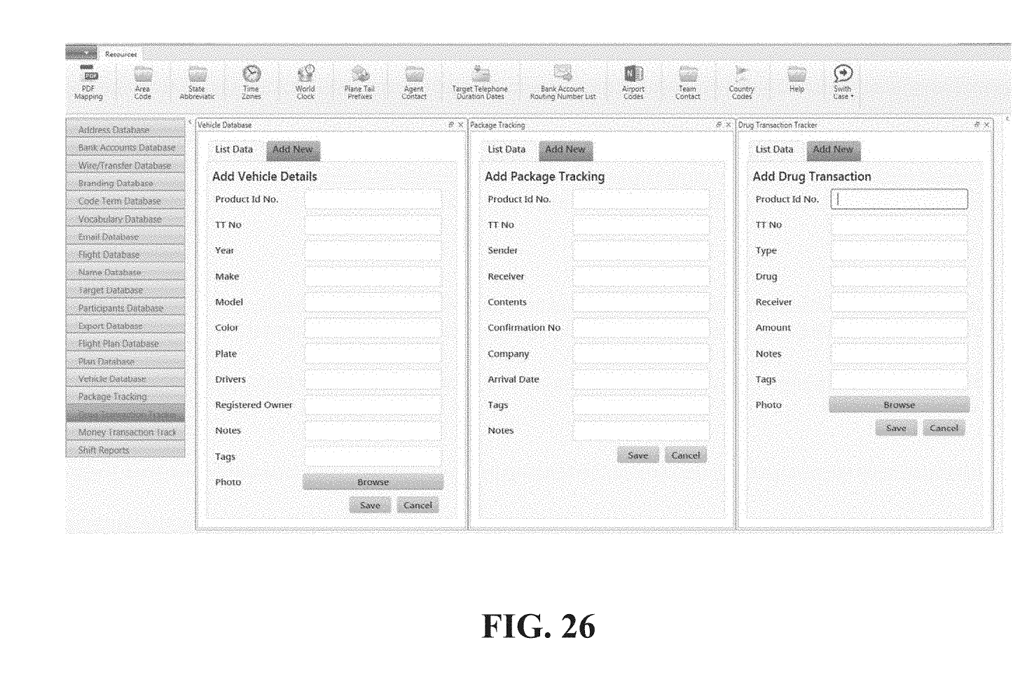

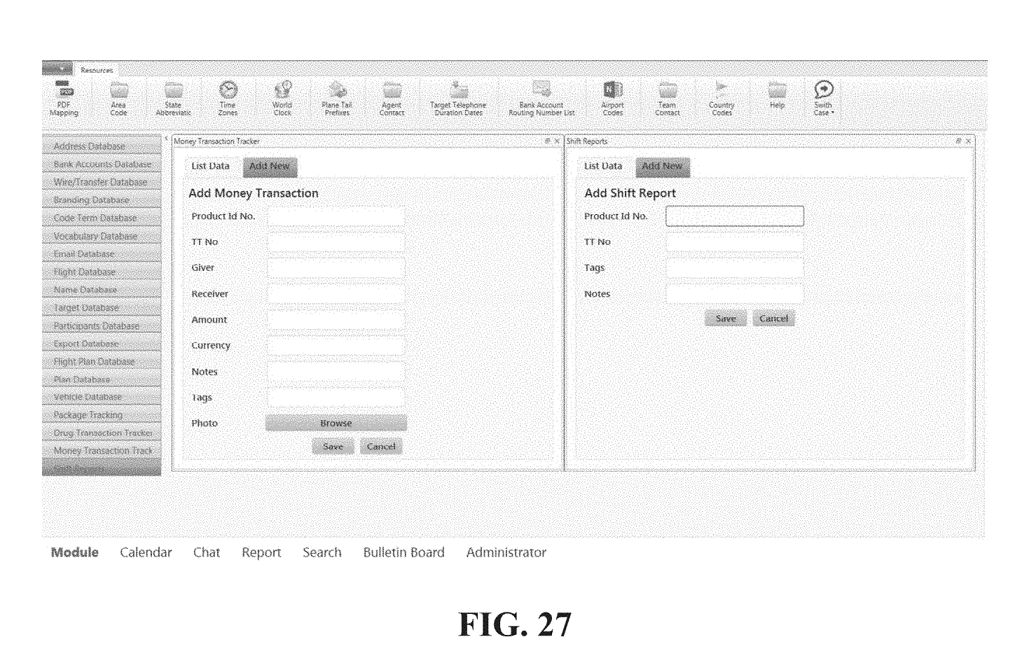

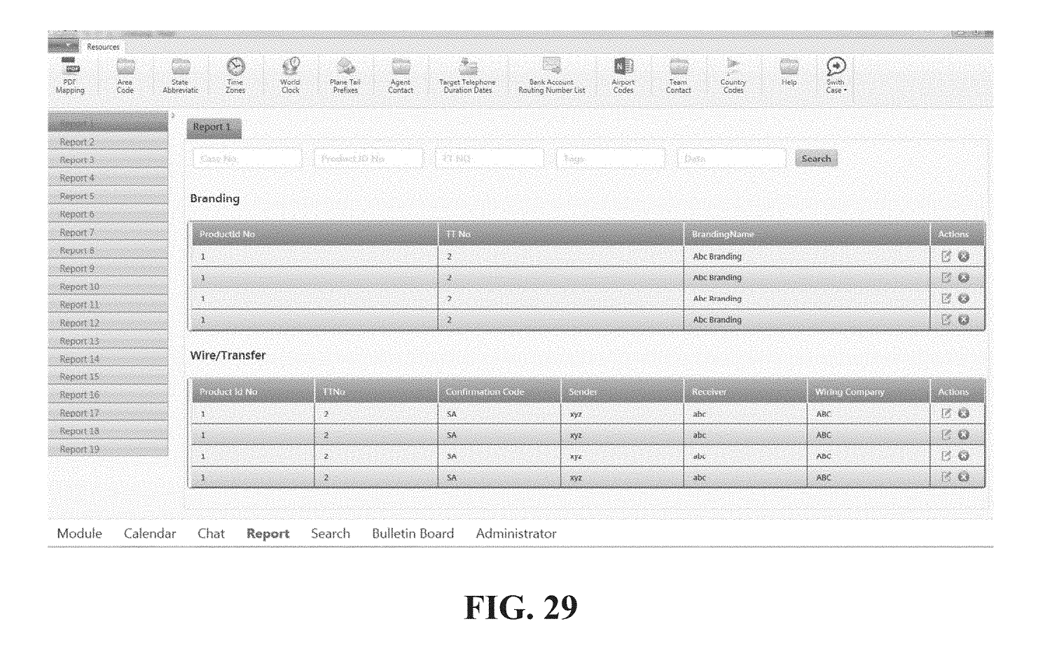

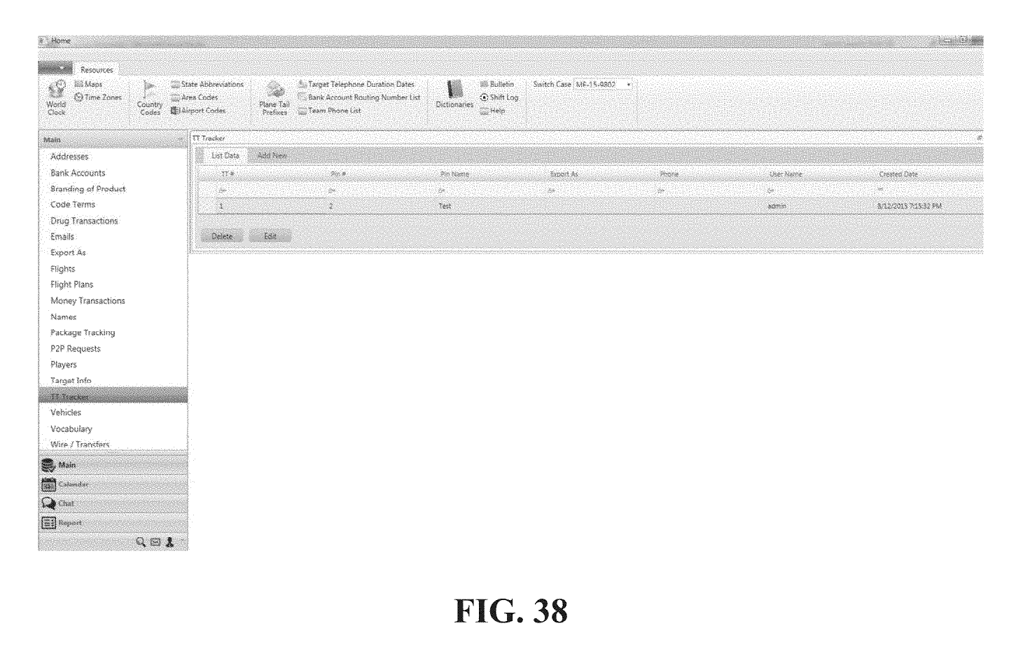

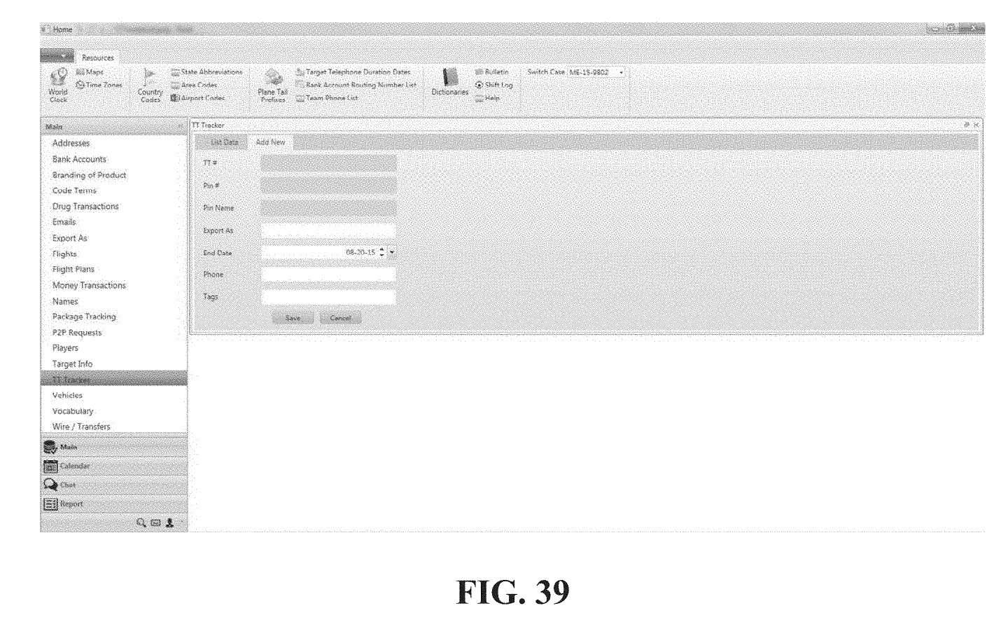

FIGS. 3-41 illustrate an exemplary GUI database management system for an investigation according to various embodiments. FIG. 3 illustrates an exemplary GUI having icons across the top of the screen labeled with various labels, such as Maps, Area Codes, State Abbreviations, Time Zones, World Clock, Plane Tail Prefixes, Team Phone List, Target Telephone Duration Dates, Bank Account Routing Number List, Airport Codes, Country Codes, Help, Switch Cases, Dictionary, Bulletin and Shift Reports.

The Maps icon may allow users to read various maps, including interactive maps or links to official databases or websites based on various location information. For example direct links to official government (local, state, and/or federal) websites such as the Federal Aviation Administration (FAA), U.S. Post Office, or Federal Bureau of Investigation (FBI). The aforementioned maps may include, for example, interactive maps of the United States, Canada, and Mexico.

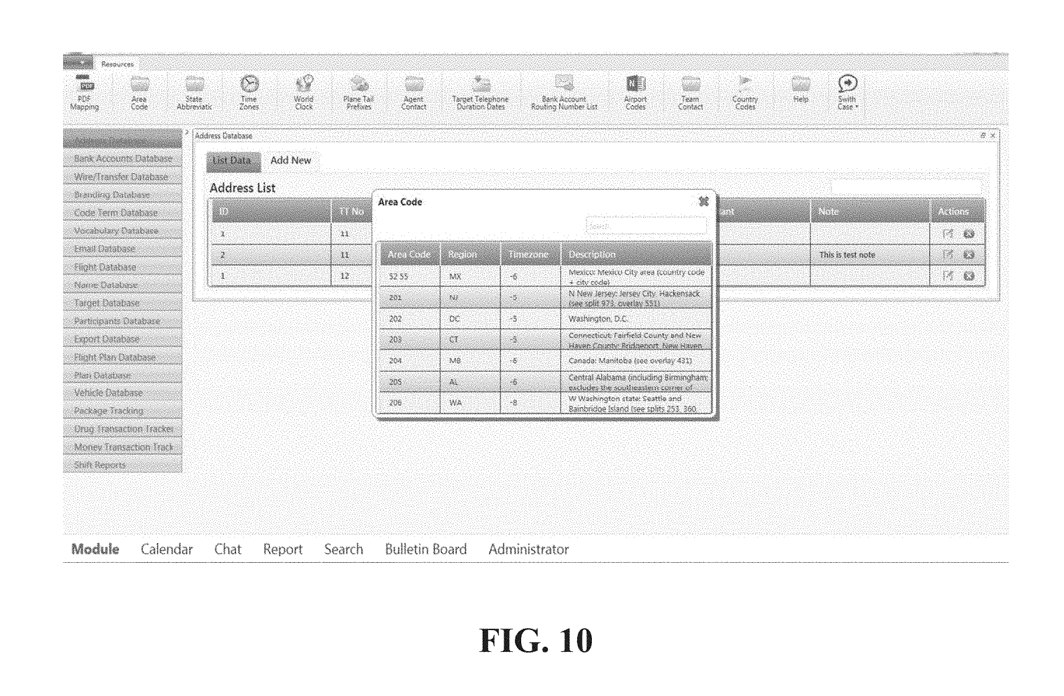

As mentioned earlier, location information may include area codes. The exemplary GUI may include an icon that reads area codes which will allow users to instantly search for and find the geographical or type of number that is associated with a particular area code, for example as illustrated in FIG. 10. The list may also provide the state and specific region (e.g., city or portion of a state) where that area code is used.

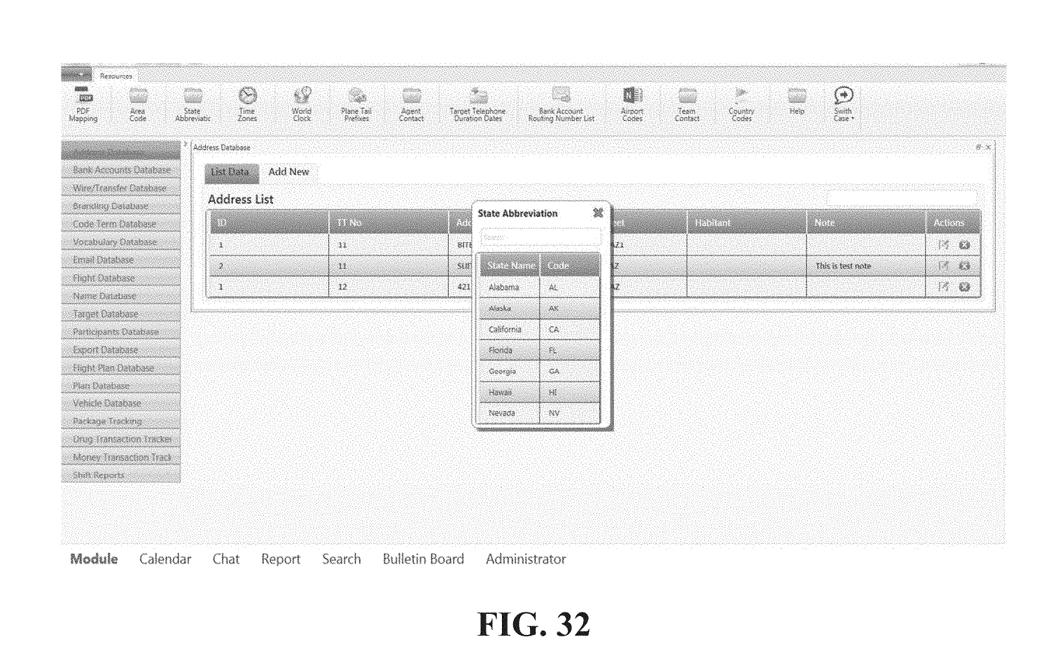

The State Abbreviations icon may give the software users (e.g., end users) the state abbreviation to the states in a country, such as Canada or the United States, for example, as illustrated in FIG. 32.

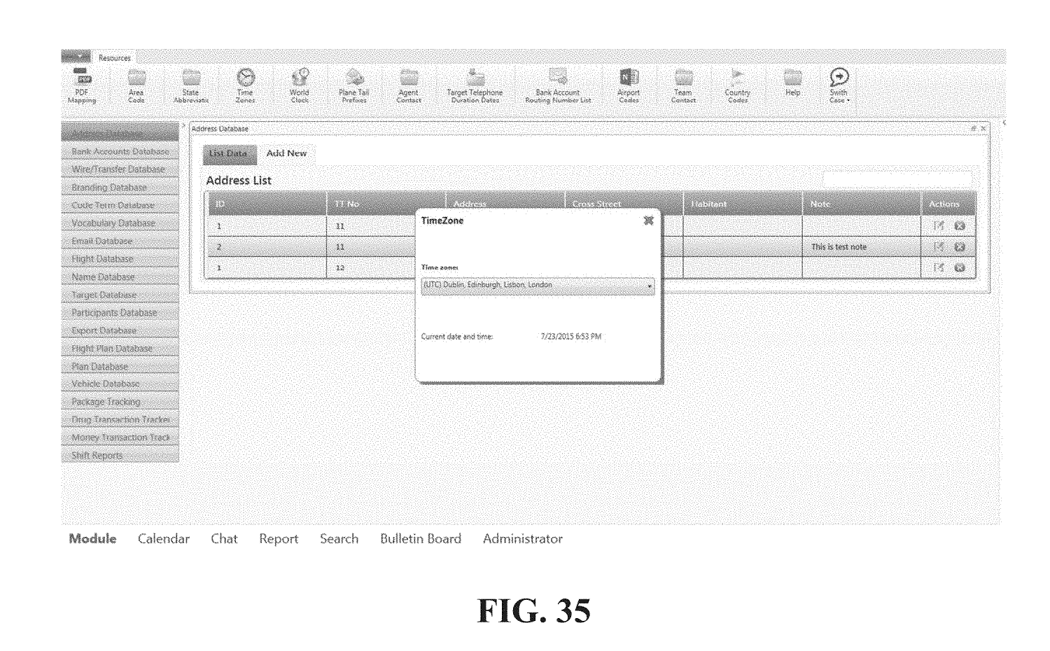

The Time Zones icon may allow users to select a time zone from a drop down and see the time in that specific part of the world, as illustrated in FIG. 3, or a full view window (illustrated in FIG. 35). In various embodiments, when a window is pulled up it may have a drop down for the time zone the user wishes to see but also have the current date and time on the bottom of the window for the users' convenience, as illustrated in FIG. 35.

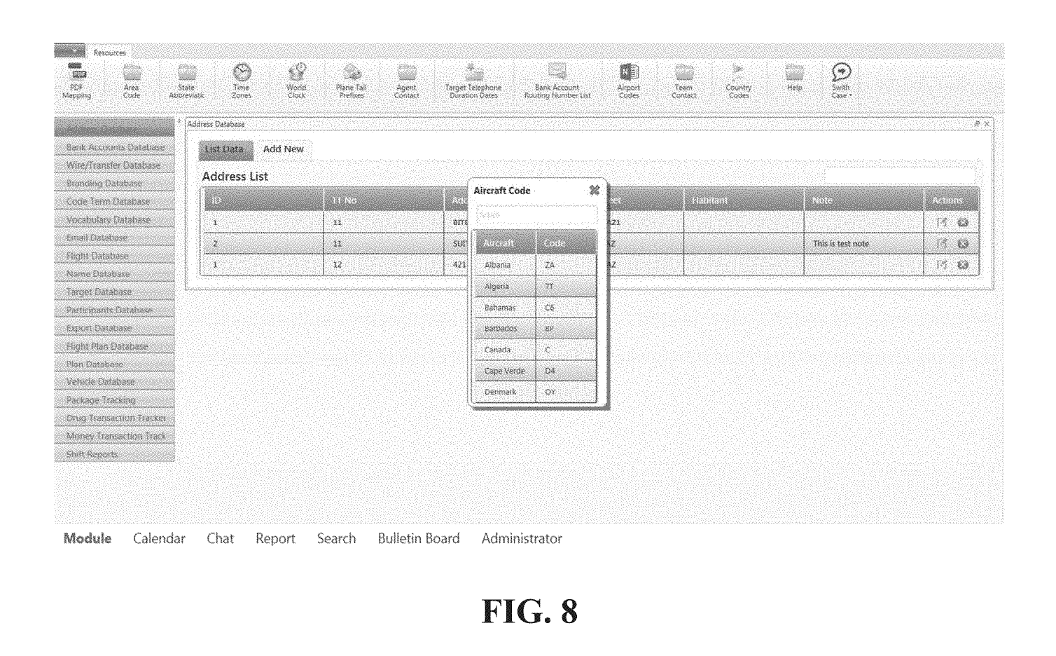

The Plane Tail Prefixes icon, illustrated in FIG. 3, may allow users to be able to search any plane prefix and see which country or region the aircraft is licensed, as exemplified in FIG. 8.

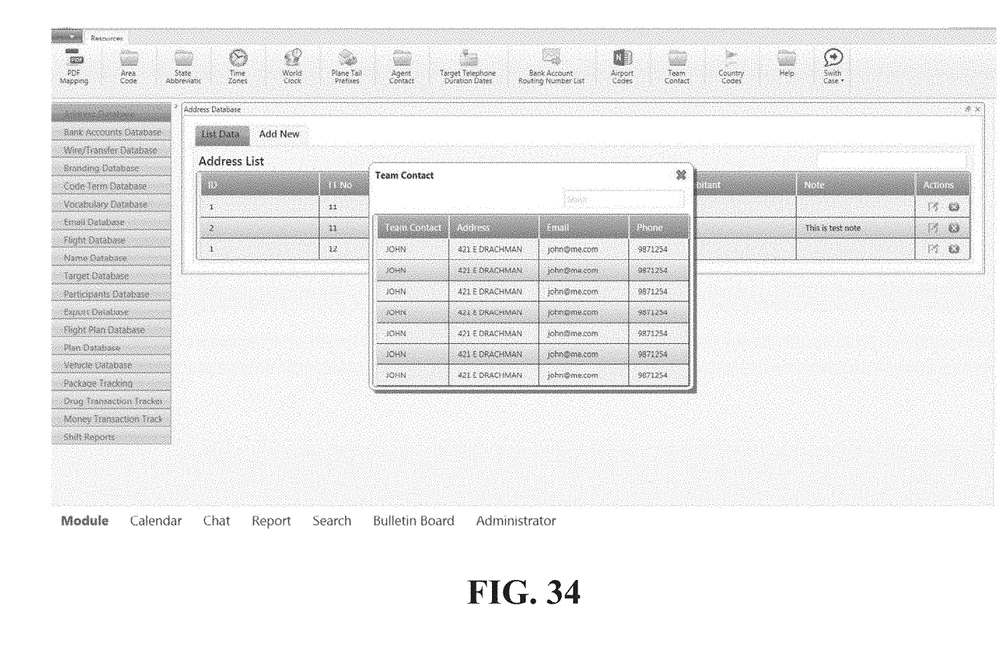

The Team Phone List icon may allow users to view some or all phone numbers that are entered into the system by the case supervisor for some or all of the individuals working the case. Should any other team member need to contact another team member who is a part of the investigation, their phone numbers may be easily accessible with this option, which may open the full view window exemplified in FIG. 34.

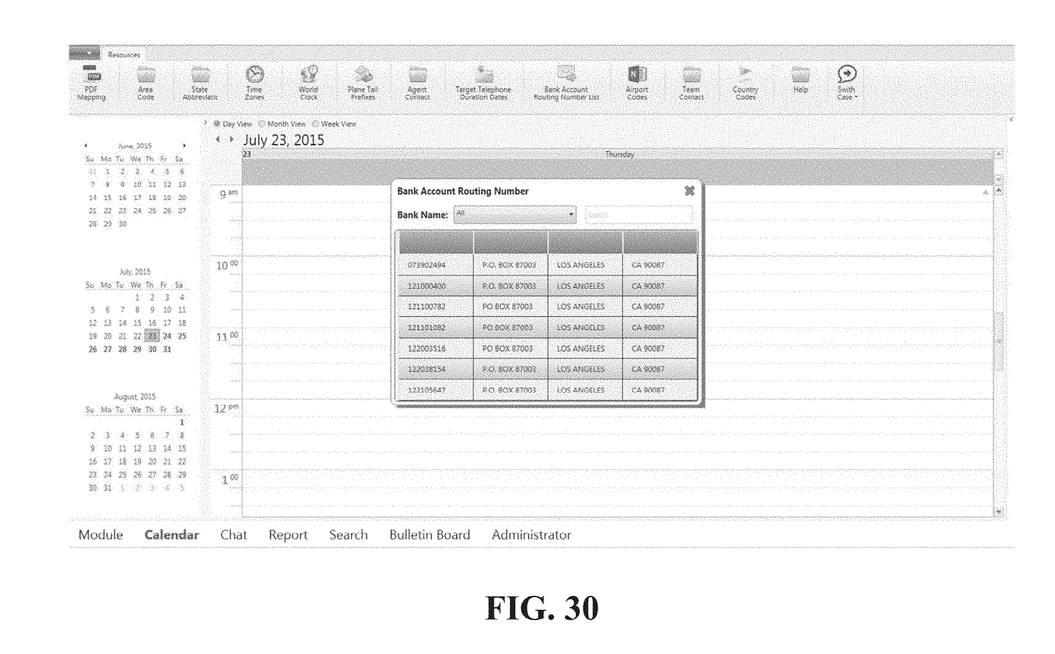

The Bank Account Routing Number list may open a new GUI window and may give users a partial or complete list of bank routing numbers within the US or outside the U.S. Users may be able to search either by location, bank name, routing number, or mixtures thereof during the investigation, as shown in FIG. 30.

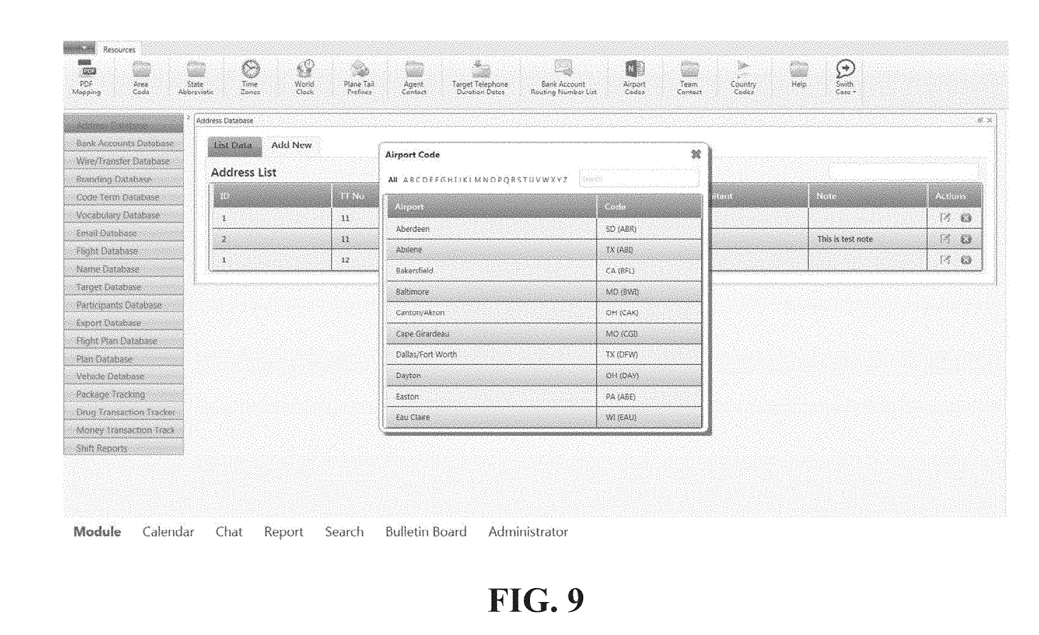

The Airport Codes icon may open a new window and may list Airport codes around the world. Users may be able to search any airport code by location, state, country or airport code, as illustrated in FIG. 9.

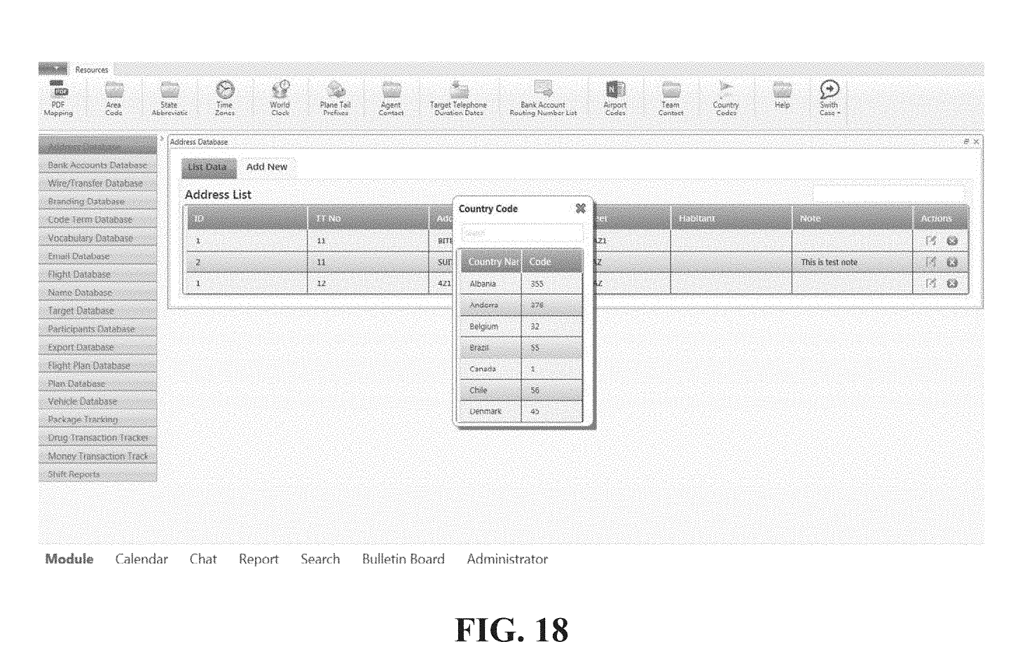

The Country Codes icon may open a new window in the GUI and may List Country Codes for phone numbers around the world, as shown in FIG. 18.

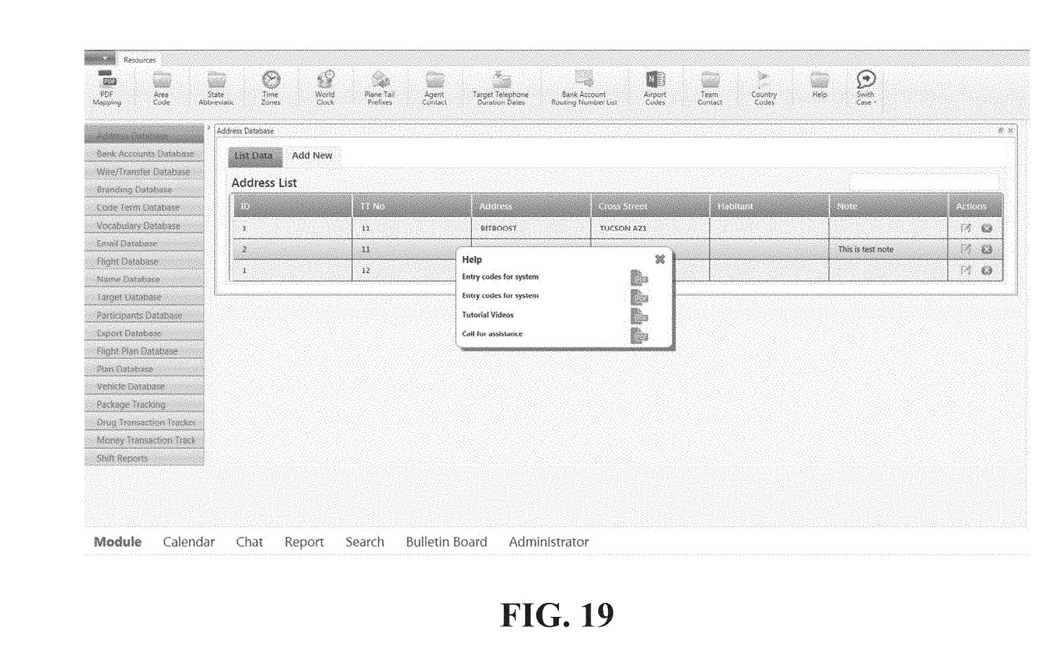

The database management system and methods may include a help menu. The help menu may be configured to assist users with any questions regarding how to use a piece of software or any components within the software having the embodiment disclosed herein, as shown in FIG. 19.

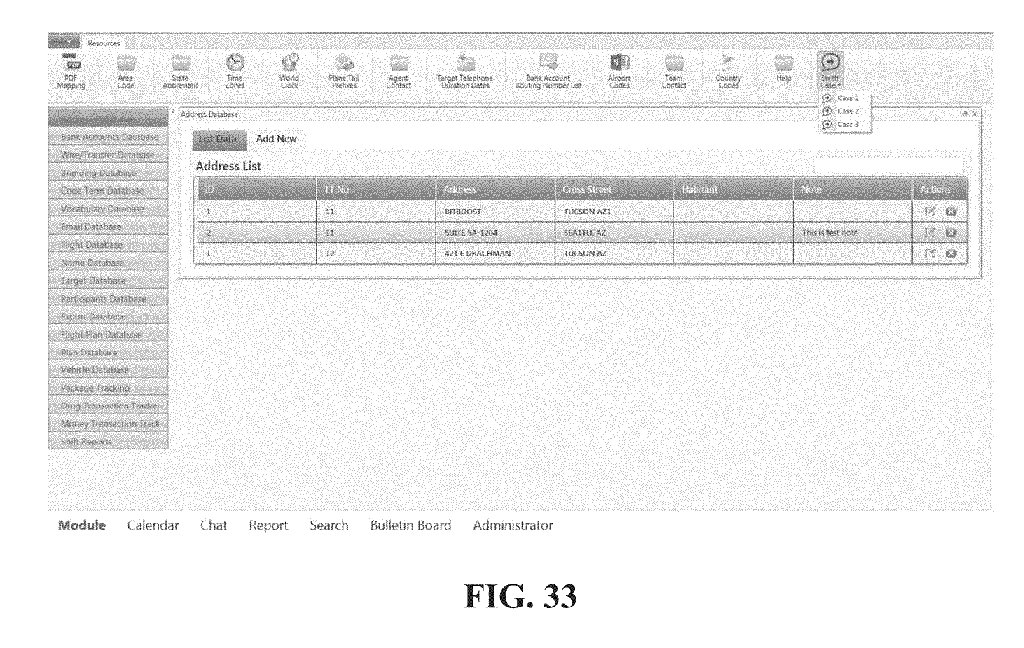

The Switch Cases icon may allow a user to initiate a drop down and may enable the users to switch between cases (as illustrated is FIG. 33), for example, if they have been assigned to multiple cases within their department/office.

The dictionaries icon may initiate a drop down menu and allow users to have the option of selecting various lexical resource information, such as dictionaries, (e.g., English, English Urban, Spanish, and Spanish Urban). In various embodiments, the dictionaries may be customizable within a case, or may be used to update master dictionaries that may be applied to related or unrelated cases.

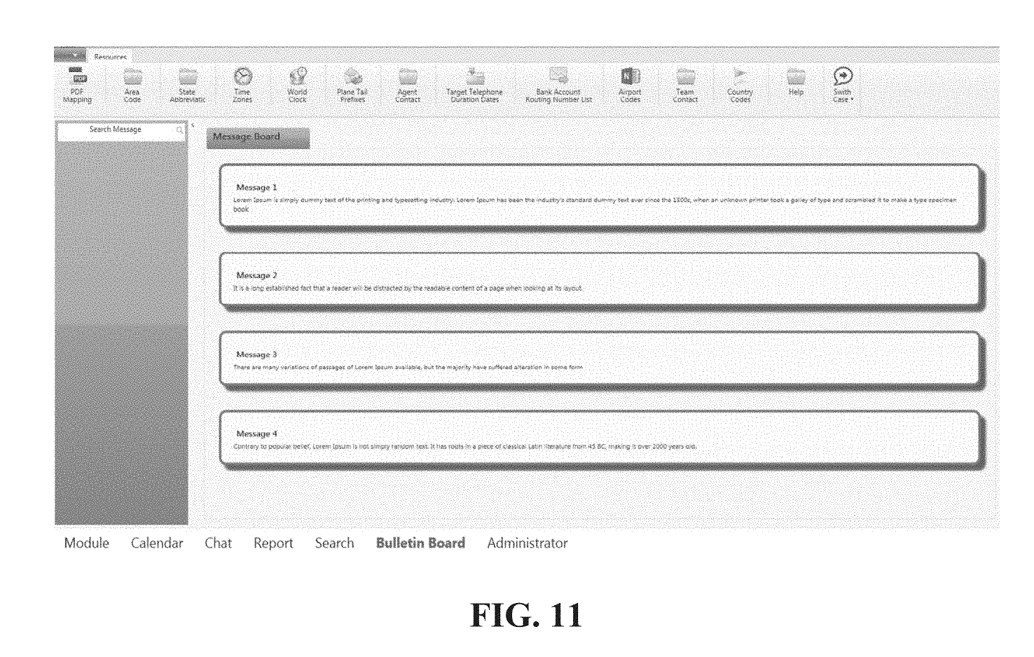

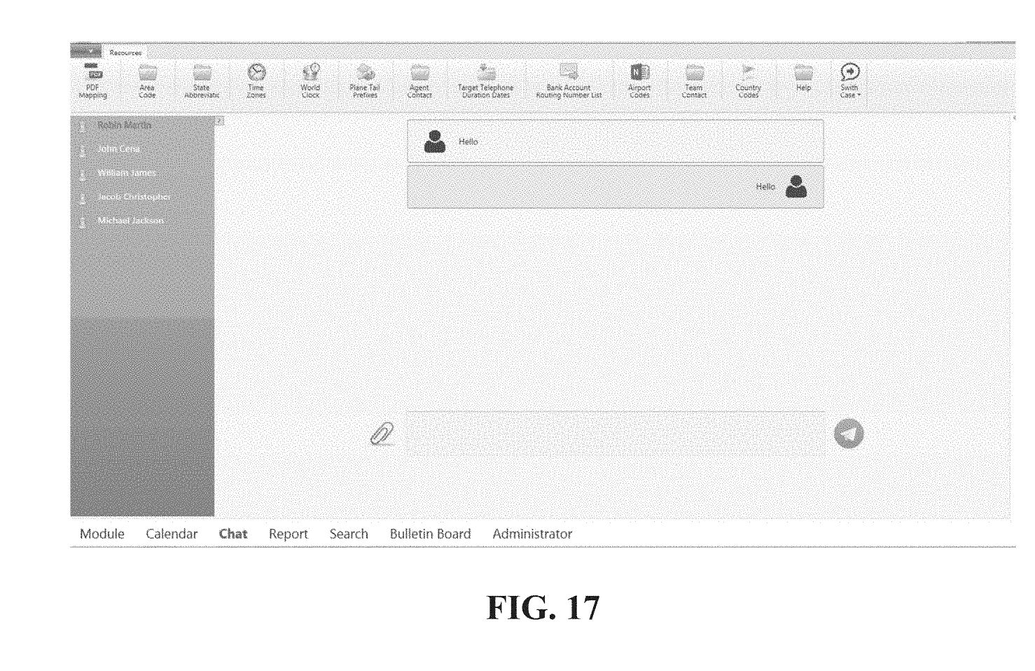

The Bulletin window, illustrated in FIG. 11, may allow some or all users to see various notes or publications posted by the case supervisor. The view of these messages may be similar to a chat setting (illustrated in FIG. 17), where messages may be viewed as bubbles as a communication method between all team members as a form of keeping the entire investigative team up to date with the latest on the investigation procedures and/or developments.

The Shift Reports icon in the exemplary GUI may be accessed by all users in order to find the most current occurrences of what has been going on in the investigation. Users may post events that occurred during their shift, which may later be read and accessed by other users working on that same investigation.

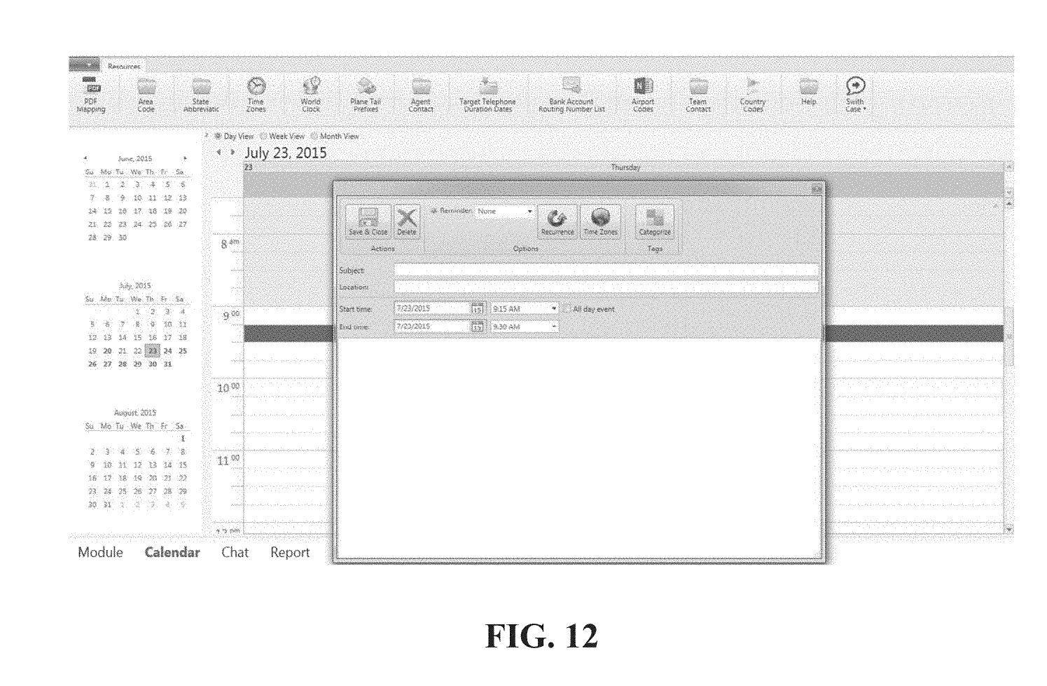

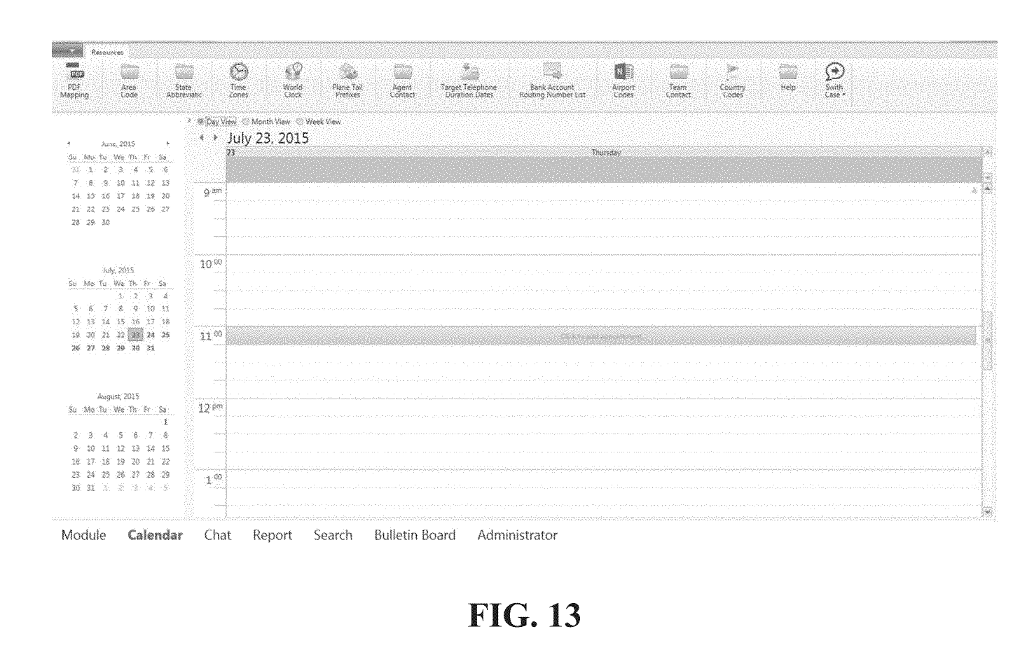

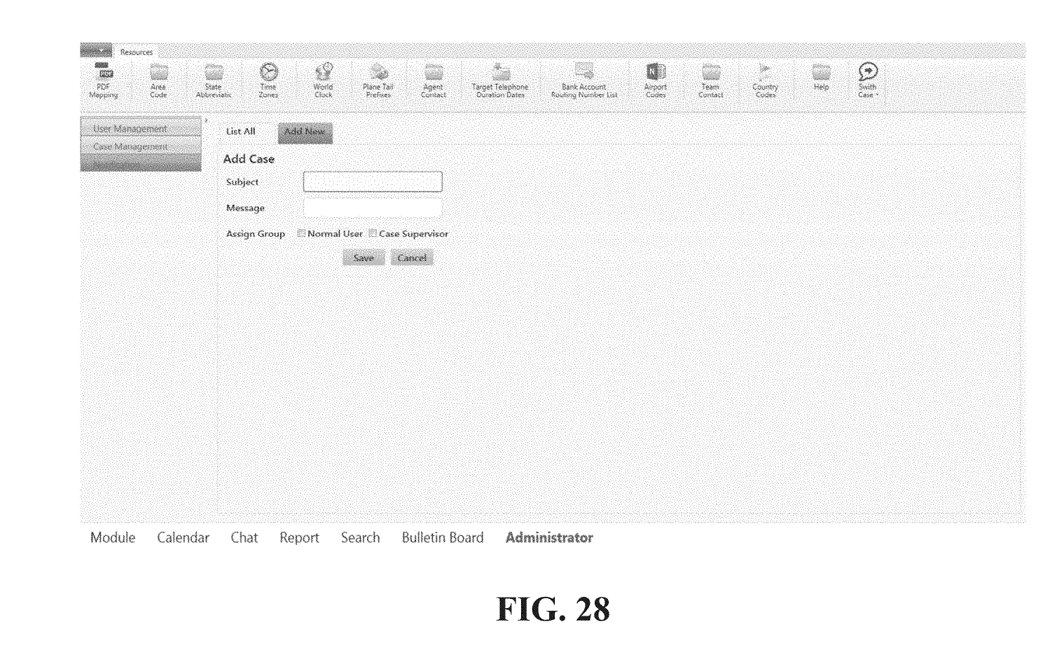

Furthermore, the exemplary GUI database management system may include methods and systems for calendaring events, both past and future within an investigation, as illustrated in FIG. 12. The calendars are not particularly limited and may include the day view, week view, or month view, as illustrated in FIGS. 13, 15, and 14, respectively. Furthermore, notifications or reminders may be generated to remind users regarding events that have occurred or may likely occur based on data gathered during an investigation, as exemplified in FIG. 28.

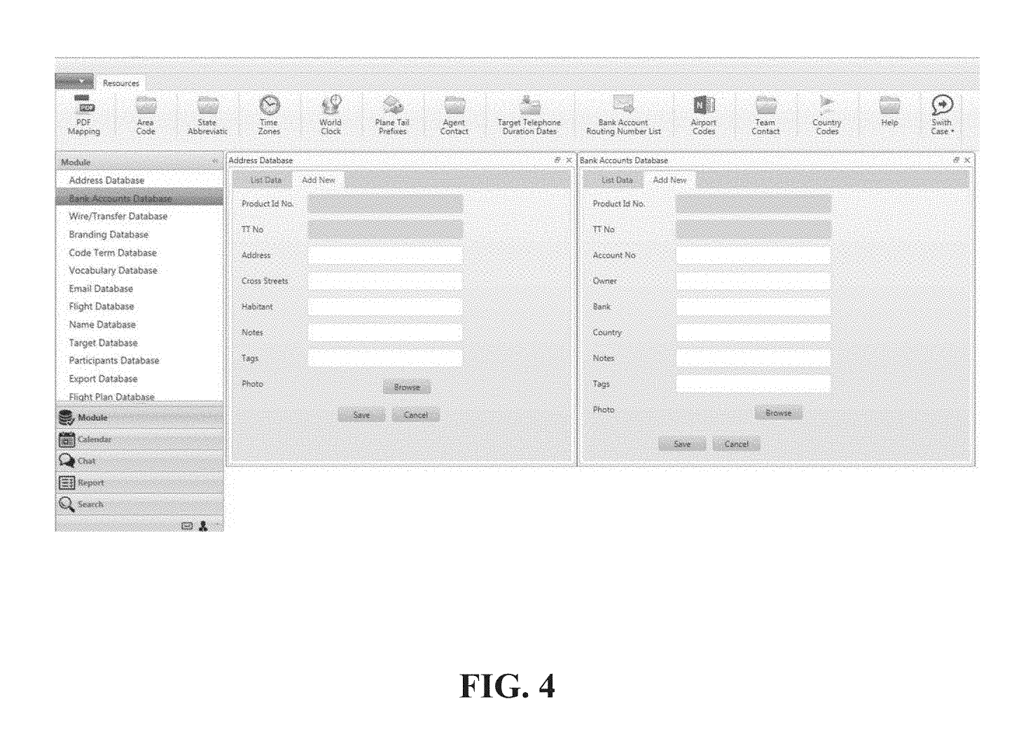

Banking information and financial information may be viewed, inputted, analyzed, and/or reported as shown in FIGS. 4, 21, and 27.

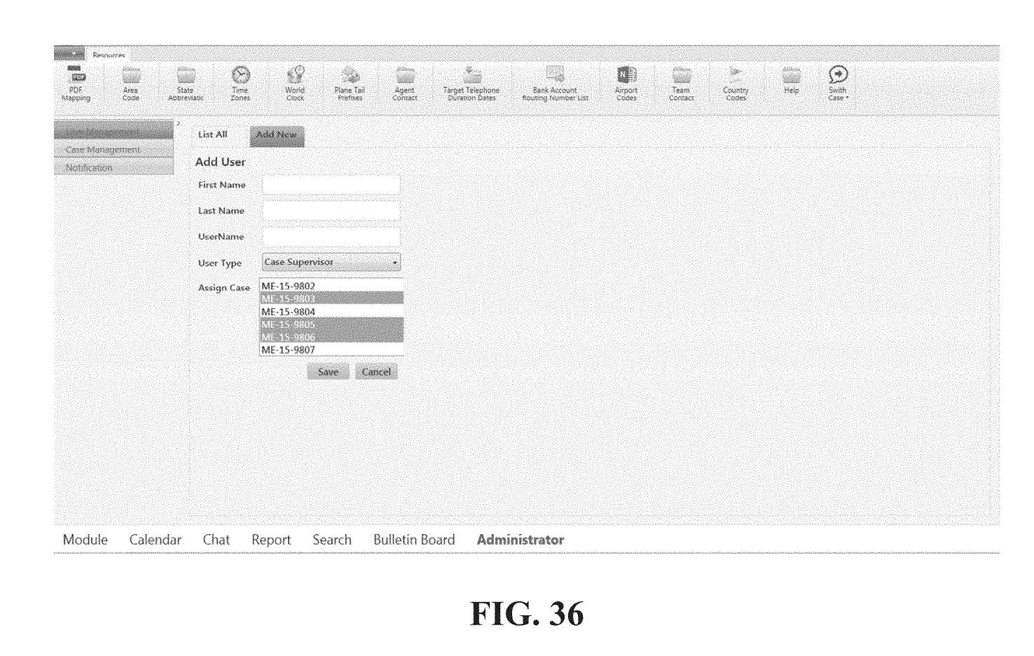

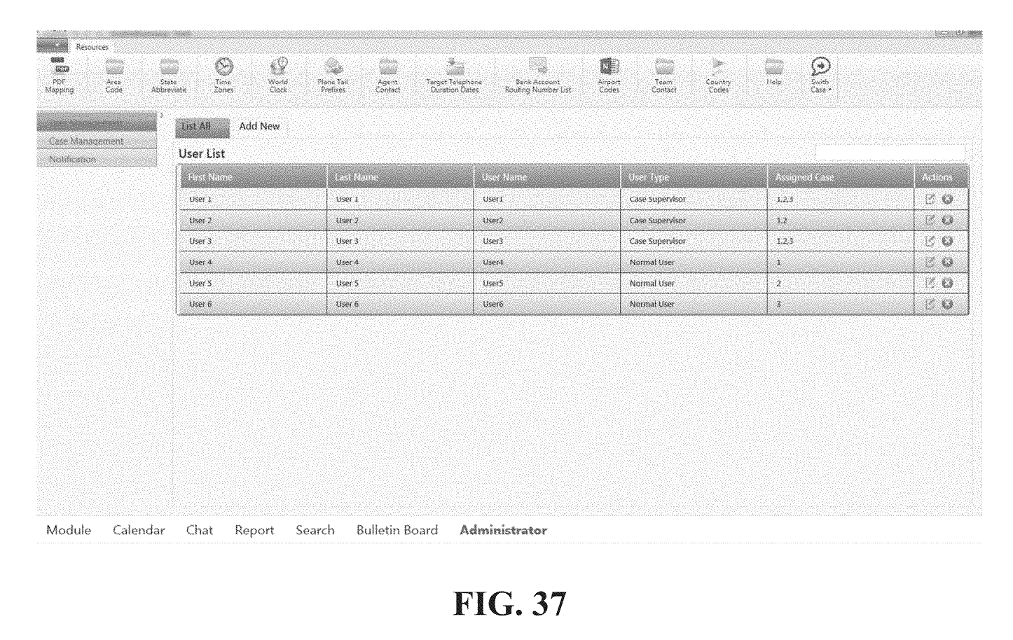

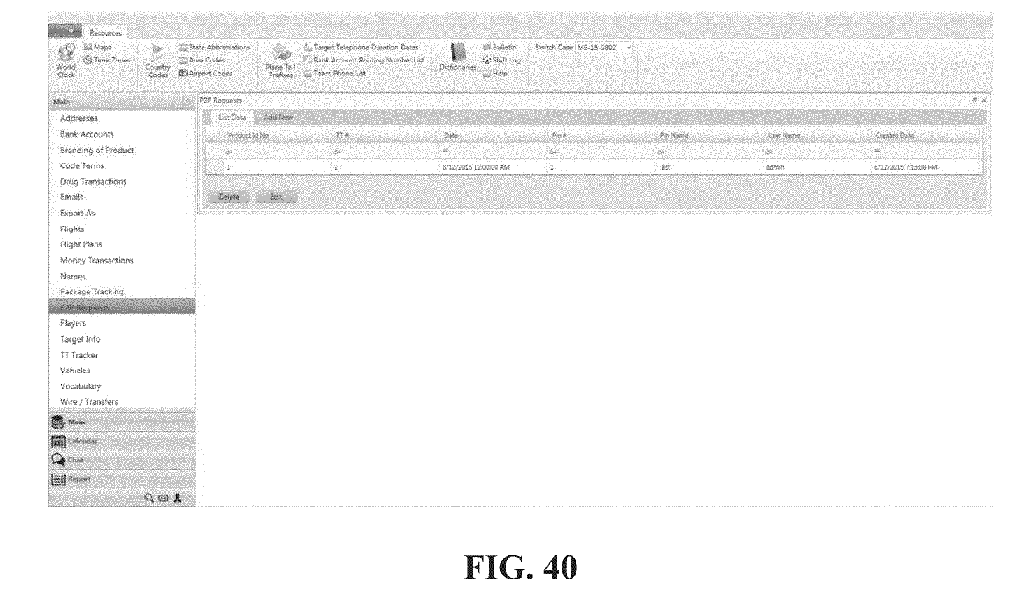

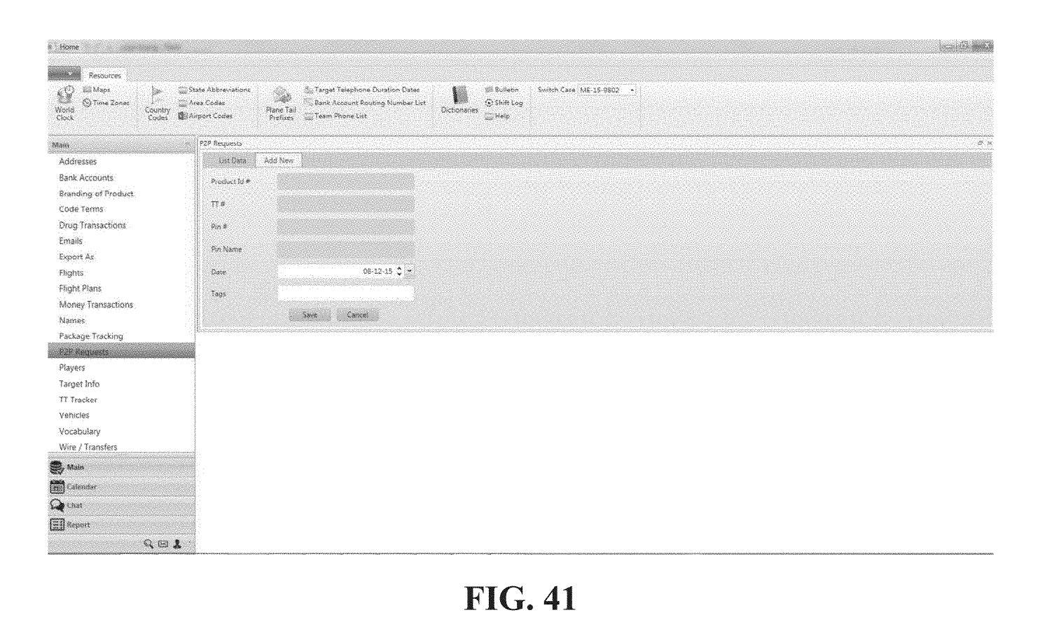

Account user information likewise may be added, edited, viewed, and analyzed, as illustrated in FIGS. 36 and 37. Furthermore, the exemplary GUI contains the ability for users to make and view pin-to-pin (“P2P”) requests as shown in FIGS. 40 and 41.

FIGS. 4, 5, 6, 7, 20, 22-25, 29, 38, and 39 illustrate various views and various modules of the exemplary GUI database management system. As evident from these FIGs., the data about an investigation is not particularly limited and can vary depending the nature of the investigation (e.g., drug transfers, money laundering, wire fraud, identity theft).

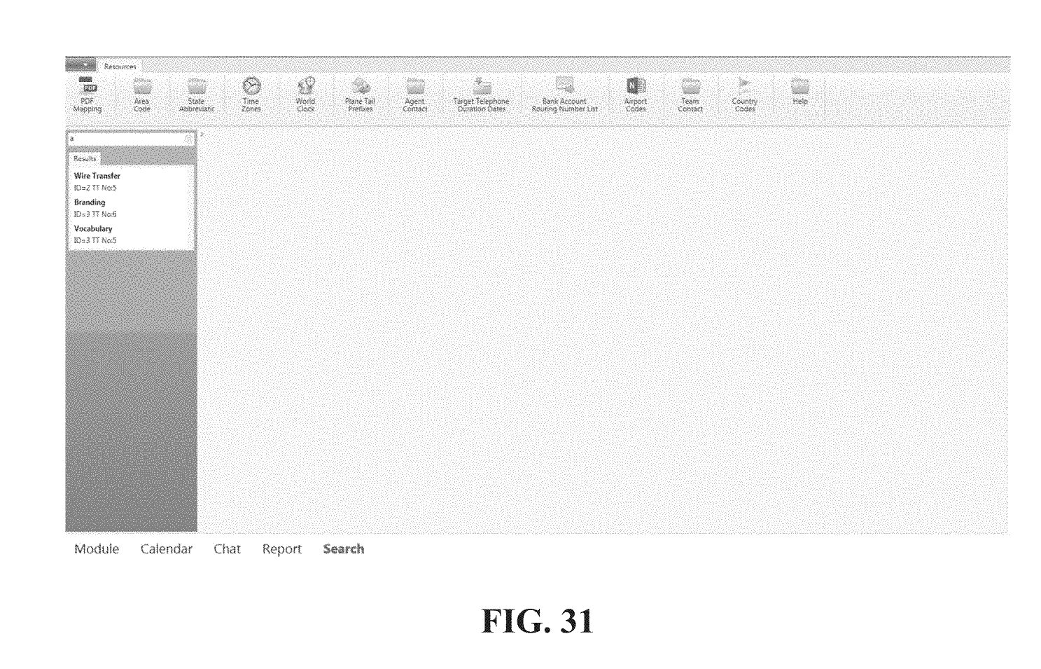

Moreover, various systems and methods may allow for the searching of tags or other important data or information contained within the database. FIG. 31 illustrates a search screen of the exemplary GUI database management system according to various embodiments.

Furthermore, the database management system is not limited to one investigation and may encompass a plurality of investigations. Thus, users may be able to switch between and/or link investigations. FIG. 33 illustrates an exemplary case menu from the exemplary GUI database management system.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system comprising:
a non-transitory, computer-readable storage medium on which a database management system is stored and configured to allow access and indexing of content items related to an investigation in a corpora of electronically stored content;
a computer machine comprising a processor in communication with the storage medium configured to:
receive a first data associated with the investigation;
receive a second data associated with the investigation;
link the first data and the second data with the investigation;
associate, by the processor, the first data with the second data; and
report, by the processor, an investigative conclusion based on the association of the first data and the second data.

2. The system of claim 1, wherein the processor is in communication with a sub-system comprising information associated with the first data associated with the investigation, the second data associated with the investigation, or both.

3. The system of claim 1, wherein the processor is in communication with a sub-system capable of displaying the investigative conclusion on a graphical user interface.

4. The system of claim 1, wherein the a processor schedules an event based on the investigative conclusion.

5. The system of claim 4, wherein the event is updated with a third data associated with the investigation.

6. The system of claim 1, wherein the database management system is configured to be modified by one or more end users.

7. The system of claim 1, wherein the database management system is configured to record and store modifications to the database management system.

8. The system of claim 1, wherein the first data associated with the investigation and the second data associated with the investigation are tagged.

9. The system of claim 8, wherein the tag links the first data associated with an investigation and the second data associated with the investigation as an investigative event.

10. A method for managing investigation data comprising:
receiving a first data associated with an investigation;
receiving a second data associated with the investigation;
linking the first data and the second data with the investigation;
associating, by a processor, the first data with the second data; and
reporting, by the processor, an investigative conclusion based on the association of the first data and the second data.

11. The method of claim 10, wherein the investigative conclusion includes location information, vehicle identifier information, property ownership information, telephonic information, banking information, transportation information, legal information, lexical resource information, correspondence information, wiretap information, videographic information, photographic information, financial transaction information, drug transfer information, access information, personal identification information, or mixtures thereof.

12. The method of claim 11, wherein the location information includes area code information, state abbreviation information, county, parish, canton, or shire information, jurisdictional information, airport code information, time zone information, country code information, or mixtures thereof.

13. The method of claim 11, wherein the correspondence information includes author information, sender information, recipient information, time stamp information, subject matter information, attachment information, shipping information, tracking information, or mixtures thereof.

14. The method of claim 11, wherein the vehicle identifier information includes license plate information, vehicle identification number (“VIN”) information, plane tail identification information, make of the vehicle information, model of the vehicle information, series of the vehicle information, color of the vehicle information, customization of the vehicle information, capacity of the vehicle information, or mixtures thereof.

15. The method of claim 11, wherein the transportation information includes estimated time of arrival (“ETA”) information, time of departure information, flight information, booking information, commute time information, gate information, dock information, container information, carrier information, shipping information, bearing information, companion information, debark information, embarking information, seating information, luggage information, port information, cab information, track information, traffic information, parking information, or mixtures thereof.

16. The method of claim 11, wherein the personal identification information includes mug shots, gang affiliation information, cartel affiliation information, relationship information, genealogical information, educational information, professional licensure information, social security numbers, driver's license numbers, birthdate, age, height information, weight information, religious affiliation, ethnicity, nationality, scars and marks information, eye color, biographical information, internet protocol (“IP”) address information, alias information, account user information, address information, or mixtures thereof.

17. The method of claim 11, wherein the banking information includes bank account numbers, balances, routing numbers, check numbers, wiring information, credit information, net worth information, loan information, investment information, credit card information, debit card information, account statements, check image information, portfolio information, mortgage information, asset allocation information, liability allocation information, currency information, or mixtures thereof.

18. The method of claim 11, further comprising scheduling an event based on the investigative conclusion.

19. The method of claim 18, further comprising updating the scheduled event based on a third data associated with the investigation.

20. The method of claim 11, wherein the first data associated with the investigation and the second data associated with the investigation are received from two separate end users.

21. The method of claim 20, wherein the first data associated with the investigation and the second data associated with the investigation are received simultaneously.
